(19) United States
(12) Patent Application Publication
(10) Pub. No.: US 2021/0060883 A1
(43) Pub. Date: Mar. 4, 2021

(54) TIRE MOLDING APPARATUS

(71) Applicant: Toyo Tire Corporation, Itami-shi (JP)

(72) Inventors: Hiroaki Morino, Itami-shi (JP); Katsuji Niwa, Itami-shi (JP)

(73) Assignee: Toyo Tire Corporation, Itami-shi (JP)

(21) Appl. No.: 16/996,138

(22) Filed: Aug. 18, 2020

(30) Foreign Application Priority Data
Sep. 2, 2019 (JP) 2019-159795
Sep. 2, 2019 (JP) 2019-159798
Sep. 2, 2019 (JP) 2019-159802

(51) Int. Cl. B29D 30/20; B29D 30/00

(52) U.S. Cl. CPC B29D 30/20; B29D 30/0016; B29D 2030/202; B29D 2030/0022; B29D 2030/0066

(57) ABSTRACT

A tire molding apparatus includes: a moving body which moves and stops along a rail; and a position information acquiring device which acquires information of a stop position of the moving body, in which the position information acquiring device includes at least a reflector and a sensor as components, in which one component of the reflector and the sensor is provided facing the moving body in a stopped state, in which the moving body is provided with the other component of the reflector and the sensor, in which the one component is disposed at a position outside a movable range of the moving body, in which a reflection surface of the reflector is inclined with respect to an extension direction of the rail, and in which the information of the stop position of the moving body is acquired on the basis of the distance measured by the sensor.

### REFERENCE OF RELATED APPLICATIONS

This application is based on Japanese patent applications 2019-159802, 2019-159795, and 2019-159798 (all filing dates: Sep. 2, 2019) and enjoys the priority benefits of the above three applications. This application is intended to include all of the contents of the above three applications by reference to the above three applications.

### TECHNICAL FIELD

The present invention relates to a tire molding apparatus.

### BACKGROUND ART

As described in Patent Document 1 or Patent Document 2, a tire molding apparatus including a carcass drum, a belt drum, and a shaping drum is known. A carcass band which is a tire member including a carcass is molded on the carcass drum. An outer member which is a tire member including a belt and a tread is molded in the belt drum. The carcass band and the outer member are integrated in the shaping drum to mold a green tire.

A transfer device is used to move the tire member between the drums. Specifically, the transfer device receives the carcass band from the carcass drum, moves to the position of the shaping drum, and transfers the carcass band to the shaping drum. Further, another transfer device receives the outer member from the belt drum, moves to the position of the shaping drum, and transfers the outer member to the shaping drum.

Further, the carcass drum and the belt drum move from the molding position of the tire member to the transfer position of the tire member and transfer the tire member to the transfer device. Further, the shaping drum moves from a standby position to the reception position of the tire member and receives the tire member from the transfer device.

The transfer device and the drum (hereinafter, “moving bodies”) move along a rail by a servo motor and stop at the reception position, the transfer position, or the like of the tire member. A moving body is basically stopped by the control of the servo motor. Further, the moving body is stopped by a mechanical means such as a pin protruding toward the rail depending on the device.

However, there is a case in which the stop position of the moving body is deviated due to the wear of the mechanical means or other reasons as the moving body is repeatedly moved or stopped. When the stop position is deviated, the tire member cannot be attached to a correct position of the shaping drum with a correct posture and hence the uniformity of the tire is influenced.

For that reason, it is necessary for an operator to take time for an inspection while the production is stopped and the apparatus is stopped so that the stop position of the moving body is not deviated.
Patent Document 1: JP-A-2006-116817
Patent Document 2: JP-A-2013-220636

### SUMMARY OF THE INVENTION

### Technical Problem

Incidentally, since the inspection is performed only during the stop of the apparatus, there are problems that a deviation of the stop position of the moving body cannot be recognized at an early timing and a deviation of the stop position cannot be predicted in advance. As a measure against such a problem, it is also conceivable to provide a sensor capable of acquiring information of the stop position of the moving body even during the operation of the apparatus in the vicinity of the moving body. However, there is concern that such a sensor disturbs the movement of the moving body.

Here, an object of the invention is to provide a tire molding apparatus capable of acquiring information of a stop position of a moving body without disturbing the movement of the moving body.

A tire molding apparatus of the embodiment includes: a moving body which moves and stops along a rail; and a position information acquiring device which acquires information of a stop position of the moving body, in which the position information acquiring device includes at least a reflector and a sensor as components, in which one component of the reflector and the sensor is provided at a position facing the moving body in a stopped state, in which the moving body is provided with the other component of the reflector and the sensor, in which the one component is disposed at a position outside a movable range of the moving body, in which a reflection surface of the reflector is inclined with respect to an extension direction of the rail, in which the sensor is a sensor that measures a distance to the reflection surface by emitting a wave and reflecting it by the reflection surface, and in which the information of the stop position of the moving body is acquired on the basis of the distance measured by the sensor.

In the tire molding apparatus, since the sensor can measure the distance to the reflector even when the reflector is disposed at a position outside the movable range of the moving body, it is possible to acquire the information of the stop position of the moving body without disturbing the movement of the moving body.

### BRIEF DESCRIPTION OF THE DRAWINGS

FIG. 1 is a plan view when an entire tire molding apparatus is viewed from above and is a diagram when each drum and each transfer device are located each standby position.

FIG. 2 is a plan view when the entire tire molding apparatus is viewed from above and is a diagram immediately after a belt drum and a carcass drum holding a tire member are rotationally moved.

FIG. 3 is a plan view when the entire tire molding apparatus is viewed from above and is a diagram when the carcass drum and a first transfer device move to an intersection portion between a first rail and a fourth rail.

FIG. 4 is a plan view when the entire tire molding apparatus is viewed from above and is a diagram when the carcass drum returns to a standby position and the first transfer device moves to an intersection portion between the fourth rail and a second rail.

FIG. 5 is a plan view when the entire tire molding apparatus is viewed from above and is a diagram when a shaping drum moves to the intersection portion between the fourth rail and the second rail.

FIG. 6 is a plan view when the entire tire molding apparatus is viewed from above and is a diagram when the shaping drum and the first transfer device return to a standby position.

FIG. 7 is a plan view when the entire tire molding apparatus is viewed from above and is a diagram when a second transfer device moves to the standby position of the shaping drum.

FIG. 8 is a diagram in which the second transfer device is viewed from an axial direction and is a diagram at a transfer position of a belt member from the belt drum to the second transfer device, where the belt drum is not illustrated.

FIG. 9 is a diagram in which the second transfer device is viewed from the left side in FIG. 8.

FIG. 10 is a block diagram of a laser displacement meter, a storage device, and the like.

FIG. 11 is a diagram illustrating a first laser displacement meter and an upper reflector and is a diagram when viewed from the same direction as that of FIG. 9.

FIG. 12 is a diagram illustrating a first laser displacement meter and an upper reflector of a modified example of Embodiment 1 and is a diagram when viewed from the same direction as that of FIG. 9.

FIG. 13 is a diagram when a second transfer device of the modified example of Embodiment 1 is viewed from the same direction as that of FIG. 8.

FIG. 14 is a diagram when the second transfer device of the modified example of Embodiment 1 is viewed from the same direction as that of FIG. 9.

FIG. 15 is a plan view when the entire tire molding apparatus of the modified example of Embodiment 1 is viewed from above and is a diagram when each drum and each transfer device are located at each standby position.

FIG. 16 is a front view of the entire tire molding apparatus of the modified example of Embodiment 1 (a diagram when viewed from the lower side in FIG. 15) and is a diagram when each drum and each transfer device are located at each standby position.

FIG. 17 is a diagram when a positional relationship between a laser displacement meter and a reflector is opposite to that of the case of FIG. 9 and is a diagram when the second transfer device is viewed from the same direction as that of FIG. 9.

FIG. 18 is a front view of a shaping drum of Embodiment 2 (a diagram when viewed from the lower side in FIG. 1) and is a diagram at a transfer position of a carcass band from a first transfer device to the shaping drum, where the first transfer device is not illustrated.

FIG. 19 is a diagram illustrating a first laser displacement meter and a first reflector and is a diagram when viewed from the same direction as that of FIG. 18.

FIG. 20 is a plan view when a belt drum is viewed from above.

FIG. 21 is a front view of the belt drum and is a diagram when viewed from the lower side in FIG. 20.

FIG. 22 is a side view of the belt drum and is a diagram when viewed from the right side in FIG. 20.

FIG. 23 is a block diagram of a laser displacement meter, a storage device, and the like.

FIG. 24 is a diagram illustrating a second laser displacement meter and a second reflector and is a diagram when viewed from the same direction as that of FIG. 22.

FIG. 25 is a diagram illustrating a first laser displacement meter and a first reflector of a modified example of Embodiment 2 and is a diagram when viewed from the same direction as that of FIG. 19.

FIG. 26 is a diagram when a shaping drum of the modified example of Embodiment 2 is viewed from the same direction as that of FIG. 18.

FIG. 27 is a plan view when the entire tire molding apparatus of the modified example of Embodiment 2 is viewed from above and is a diagram when each drum and each transfer device are located at the standby position.

FIG. 28 is a front view of the entire tire molding apparatus of the modified example of Embodiment 2 (a diagram when viewed from the lower side in FIG. 17) and is a diagram when each drum and each transfer device are located at each standby position.

### MODE FOR CARRYING OUT THE INVENTION

Embodiments will be described with reference to the drawings. The embodiments described below are merely examples and those appropriately modified without departing from the spirit of the invention are included in the scope of the invention.

### 1. FIRST EMBODIMENT

### (1) Overall Configuration of Tire Molding Apparatus

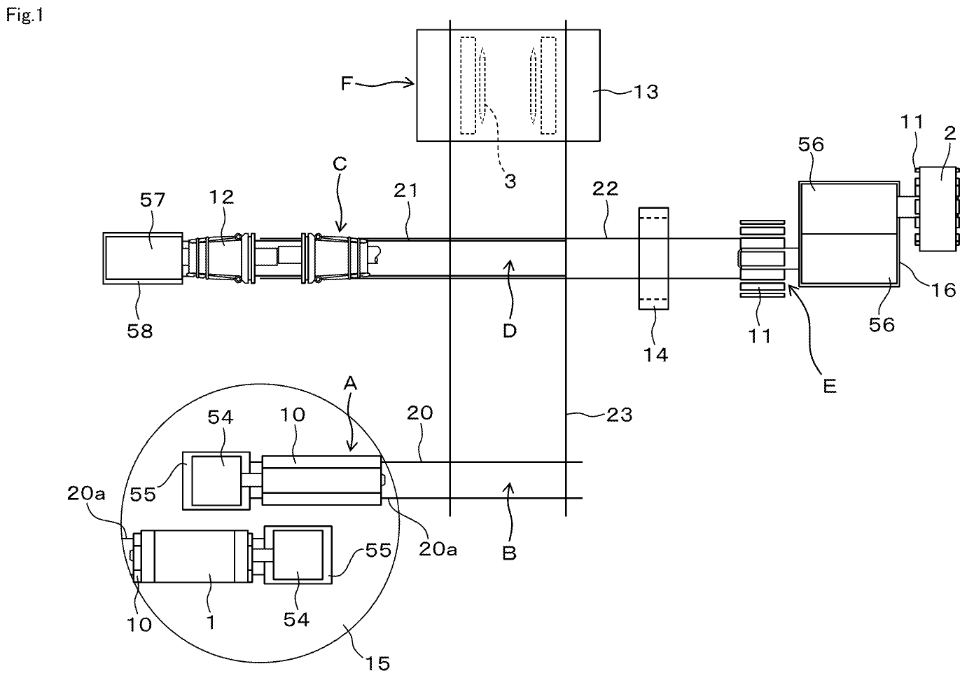

FIG. 1 illustrates a layout of a tire molding apparatus according to the embodiment. This tire molding apparatus includes a carcass drum 10, a belt drum 11, and a shaping drum 12. The carcass drum 10, the belt drum 11, and the shaping drum 12 are arranged at separate positions.

The carcass drum 10 is a drum having a known structure in which a plurality of segments are circumferentially arranged to have a cylindrical shape as a whole. When the plurality of segments move together in a drum radial direction, the outer peripheral surface of the carcass drum 10 expands or contracts. An inner liner, a carcass, or the like is attached to the outer peripheral surface of the carcass drum 10 to mold a cylindrical carcass band 1. The carcass band 1 is a kind of tire member.

The rotation shaft of the carcass drum 10 is supported by a support base 54 and the support base 54 is mounted on a movement device 55 to move along a rail to be described later.

The belt drum 11 is also a drum having a known structure in which a plurality of segments are circumferentially arranged to have a cylindrical shape as a whole. When the plurality of segments move together in a drum radial direction, the outer peripheral surface of the belt drum 11 expands or contracts. A belt, a tread, or the like is attached to the outer peripheral surface of the belt drum 11 to mold a cylindrical belt member 2. The belt member 2 is a kind of tire member. The rotation shaft of the belt drum 11 is supported by a support base 56.

The shaping drum 12 is a drum having a known structure for performing shaping. One side of the rotation shaft of the shaping drum 12 is supported by a support base 57 and the support base 57 is mounted on a movement device 58 to move along a rail to be described later.

The carcass band 1 which is molded by the carcass drum 10 is transferred to the shaping drum 12 and is set on the outer peripheral surface of the shaping drum 12. Further, the belt member 2 which is molded by the belt drum 11 is also transferred to the shaping drum 12 and is disposed on the outer peripheral side of the carcass band 1 set on the shaping drum 12. Shaping is performed in this state and the belt member 2 is attached to a place where the carcass band 1 is toroidal so that a green tire is molded.

Further, the tire molding apparatus includes a first transfer device 13 and a second transfer device 14. The first transfer device 13 is a device that receives the carcass band 1 from the carcass drum 10 and transfers the carcass band to the shaping drum 12. The first transfer device 13 has a known structure in which a plurality of segments are circumferentially arranged to form a cylinder and the segments can be moved forward and backward together in the radial direction. When the plurality of segments move forward to the inner radial side, the carcass band 1 can be gripped from the outer radial side.

The second transfer device 14 is a device that receives the belt member 2 from the belt drum 11 and transfers the belt member to the shaping drum 12. The second transfer device 14 also has a known structure in which a plurality of segments are circumferentially arranged to form a cylinder and the segments can be moved forward and backward together in the radial direction. When the plurality of segments move forward to the inner radial side, the belt member 2 can be gripped from the outer radial side.

As rails for moving the drum or the transfer device, a first rail 20, a second rail 21, a third rail 22, and a fourth rail 23 are provided. All of the first rail 20, the second rail 21, and the third rail 22 are linear rails and are arranged in parallel. The fourth rail 23 is a linear rail and is orthogonal to the first rail 20, the second rail 21, and the third rail 22 to intersect them in a plan view.

The first rail 20 is configured as a pair of two rails and is disposed on a table on a floor. The first rail 20 extends from at least the standby position (indicated by A in the drawing) of the carcass drum 10 to an intersection portion (indicated by B in the drawing) with the fourth rail 23. The carcass drum 10 is movable on the first rail 20.

Further, the second rail 21 is also configured as a pair of two rails and is disposed on the table on the floor. The second rail 21 extends from at least a standby position (indicated by C in the drawing) of the shaping drum 12 to an intersection portion (indicated by D in the drawing) with the fourth rail 23. The shaping drum 12 is movable on the second rail 21.

Further, the third rail 22 is configured as a pair of two rails and is provided on a lower surface of an upper frame (not illustrated) disposed at the upper side instead of a position on the floor. The third rail 22 extends from at least the standby position C of the shaping drum 12 to a position (indicated by E in the drawing) of the belt drum 11 over the intersection portion D with the fourth rail 23. The second rail 21 is below the third rail 22. The second transfer device 14 is suspended from the third rail 22 and is movable along the third rail 22.

Further, the fourth rail 23 is also configured as a pair of two rails and is provided on the lower surface of the upper frame (not illustrated) disposed at the upper side instead of a position on the floor. The fourth rail 23 extends from the standby position (indicated by F in the drawing) of the first transfer device 13 to the intersection portion B with the first rail 20 over the intersection portion D with the second rail 21 or the third rail 22. The first transfer device 13 is suspended from the fourth rail 23 and is movable along the fourth rail 23.

Then, the intersection portion B between the first rail 20 and the fourth rail 23 is a transfer position of the carcass band 1 from the carcass drum 10 to the first transfer device 13. Further, the intersection portion D between the second rail 21 and the fourth rail 23 is a transfer position of the carcass band 1 from the first transfer device 13 to the shaping drum 12. Further, the position E of the belt drum 11 is also a transfer position of the belt member 2 from the belt drum 11 to the second transfer device 14. Further, the standby position C of the shaping drum 12 is also a transfer position of the belt member 2 from the second transfer device 14 to the shaping drum 12.

In the tire molding apparatus, two carcass drums 10 are provided. Two carcass drums 10 are disposed on a circular rotation table 15 in the opposite directions while the rotation shafts are parallel to each other. Two first rail extension portions 20a are disposed on the rotation table 15 so as to form a rotational symmetry of 180°. Each of the first rail extension portions 20a can be an extension portion of the first rail 20 on the rotation table 15 by matching the first rail 20. The carcass drum 10 is mounted on each of the first rail extension portions 20a.

When the carcass drum 10 is located at the molding position on the side opposite to the fourth rail 23 (the left side in FIG. 1), the carcass band 1 is molded on the outer peripheral surface of the carcass drum 10. Then, the rotation table 15 rotates by 180°, the carcass drum 10 moves to the standby position on the side of the fourth rail 23 (the right side in FIG. 1), and an operation for transferring the carcass band 1 from the carcass drum 10 to the first transfer device 13 is performed.

Further, the belt drum 11 is also provided at two positions. Two belt drums 11 are disposed on a circular rotation table 16 in the opposite directions while the rotation shafts are parallel to each other. When the belt drum 11 is located at the molding position on the side opposite to the second transfer device 14 (the right side in FIG. 1), the belt member 2 is molded on the outer peripheral surface of the belt drum 11. Then, the rotation table 16 rotates by 180°, the belt drum 11 moves to the standby position on the side of the second transfer device 14 (the left side in FIG. 1), and an operation for transferring the belt member 2 from the belt drum 11 to the second transfer device 14 is performed.

The carcass drum 10, the belt drum 11, the shaping drum 12, the first transfer device 13, and the second transfer device 14 are disposed so that the axial directions face the same direction except during the rotation of the rotation tables 15 and 16. The axial directions of the drum and the transfer device are parallel to the extension directions of the first rail 20, the second rail 21, and the third rail 22. Further, the shaping drum 12, the second transfer device 14, and the belt drum 11 on the side of the fourth rail 23 are coaxial to one another.

When the first transfer device 13 is located at the position B, the center axis of the first transfer device 13 and the rotation shaft of the carcass drum 10 are on the same straight line. Further, when the first transfer device 13 is located at the position D, the center axes of the first transfer device 13 and the second transfer device 14 and the rotation shafts of the belt drum 11 and the shaping drum 12 are on the same straight line.

### (2) Outline of Tire Molding Method

Before starting a detailed description, an outline of a tire molding method in such a tire molding apparatus will be described with reference to FIGS. 1 to 7.

First, the carcass drum 10, the belt drum 11, the shaping drum 12, the first transfer device 13, and the second transfer device 14 stand by at the respective standby positions illustrated in FIG. 1. In that state, first, as illustrated in FIG. 1, the carcass band 1 is molded on the carcass drum 10 located at the molding position and the belt member 2 is molded on the belt drum 11 located at the molding position.

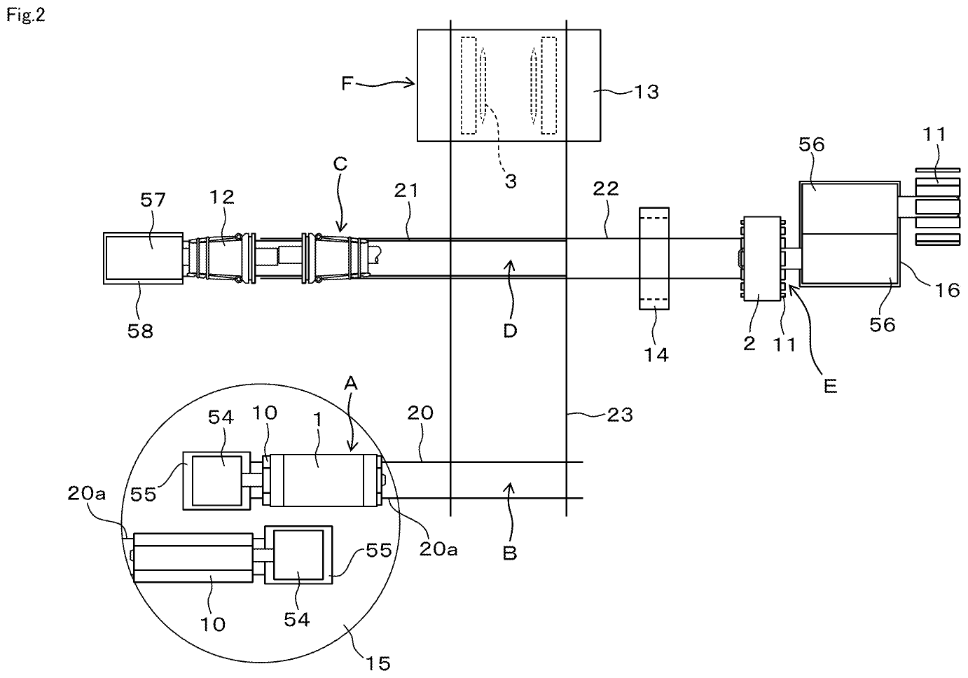

Next, each of the rotation tables 15 and 16 rotates by 180°. Accordingly, as illustrated in FIG. 2, the carcass drum 10 holding the carcass band 1 moves to the fourth rail 23 and the belt drum 11 holding the belt member 2 moves to the second transfer device 14. Further, at this time, the first transfer device 13 holds a bead 3.

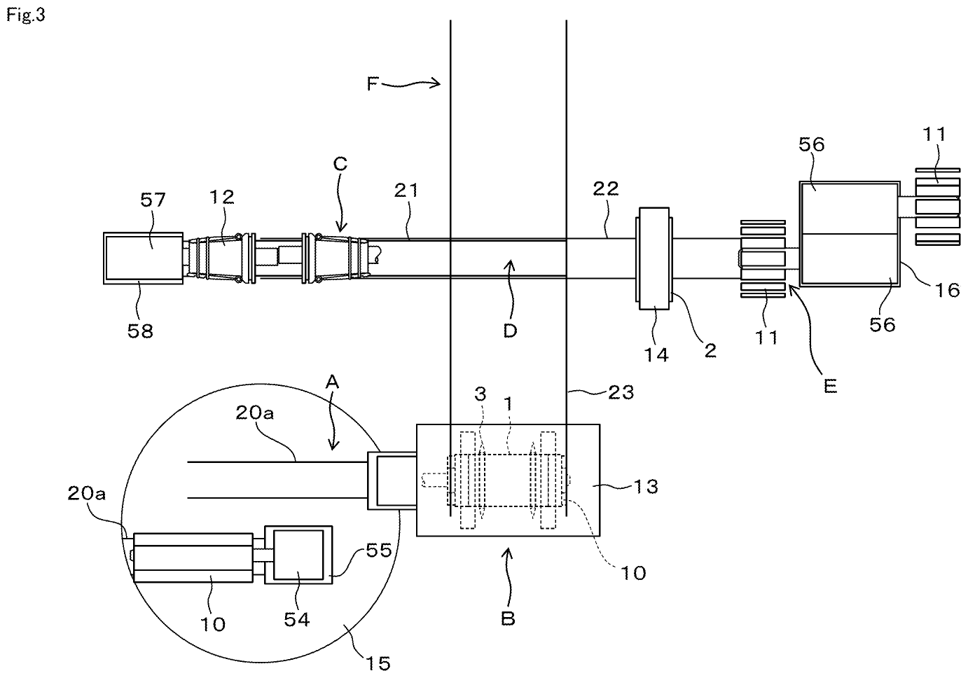

Next, as illustrated in FIG. 3, the first transfer device 13 moves from the standby position F to the intersection portion B between the first rail 20 and the fourth rail 23 and then the carcass drum 10 moves to the same intersection portion B. At this time, the carcass drum 10 enters into the circular segments of the first transfer device 13. Then, the segments of the first transfer device 13 contract to hold the carcass band 1 from the outer radial side and the segments of the carcass drum 10 contract to release the carcass band 1. Accordingly, the transfer of the carcass band 1 from the carcass drum 10 to the first transfer device 13 is completed.

During this transfer, in the first transfer device 13, the bead 3 is disposed on the outer radial side of the carcass band 1 so that the carcass band 1 and the bead 3 are integrated with each other. Then, the carcass band 1 and the bead 3 move together.

Further, the transfer of the belt member 2 from the belt drum 11 to the second transfer device 14 is performed together with the transfer of the carcass band 1 from the carcass drum 10 to the first transfer device 13. Specifically, the second transfer device 14 moves to the outer radial side of the belt member 2 held by the belt drum 11. Then, the segments of the second transfer device 14 contract to hold the belt member 2 from the outer radial side and the belt drum 11 contracts to release the belt member 2. The second transfer device 14 that receives the belt member 2 from the belt drum 11 stands by at the standby position in the vicinity of the belt drum 11.

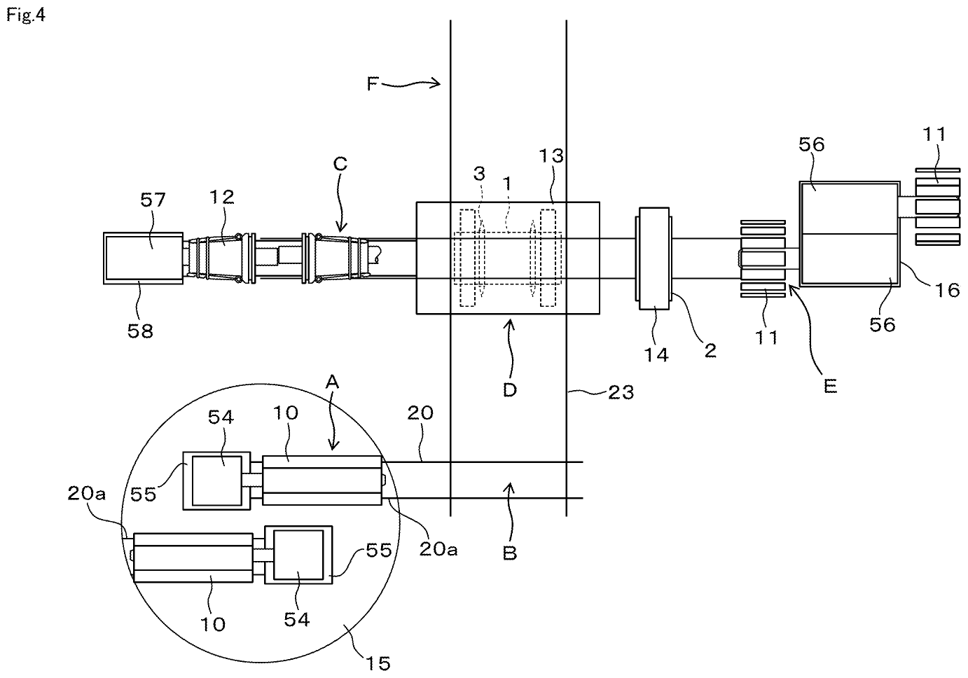

Next, as illustrated in FIG. 4, the carcass drum 10 returns to the standby position A and then the first transfer device 13 moves to the intersection portion D between the fourth rail 23 and the second rail 21 while holding the carcass band 1.

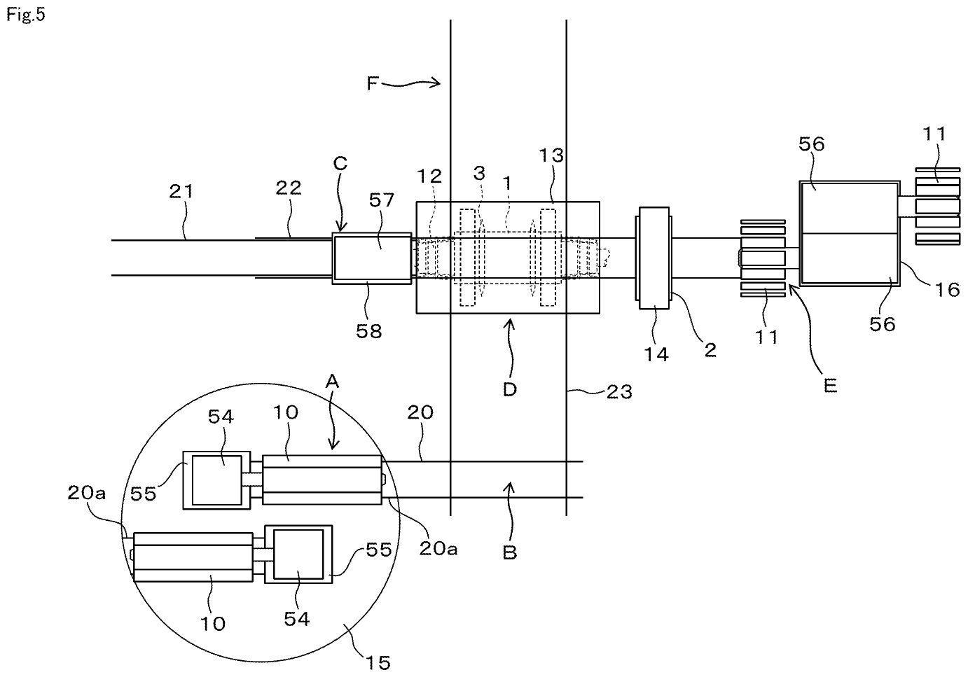

Next, as illustrated in FIG. 5, the shaping drum 12 moves to the intersection portion D between the fourth rail 23 and the second rail 21. At this time, the shaping drum 12 enters into the carcass band 1 held by the first transfer device 13. Then, the segments of the shaping drum 12 expand to hold the carcass band 1 on the outer peripheral surface thereof and the segments of the first transfer device 13 expand to release the carcass band 1. Accordingly, the transfer of the carcass band 1 from the first transfer device 13 to the shaping drum 12 is completed.

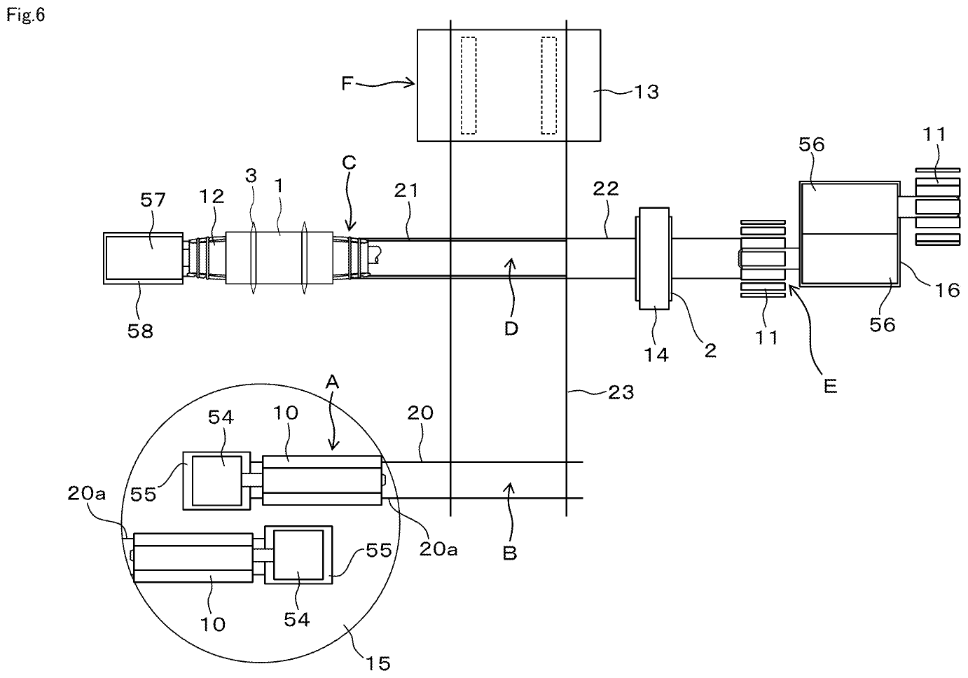

Next, as illustrated in FIG. 6, the shaping drum 12 returns to the standby position C while holding the carcass band 1 and then the first transfer device 13 returns to the standby position F.

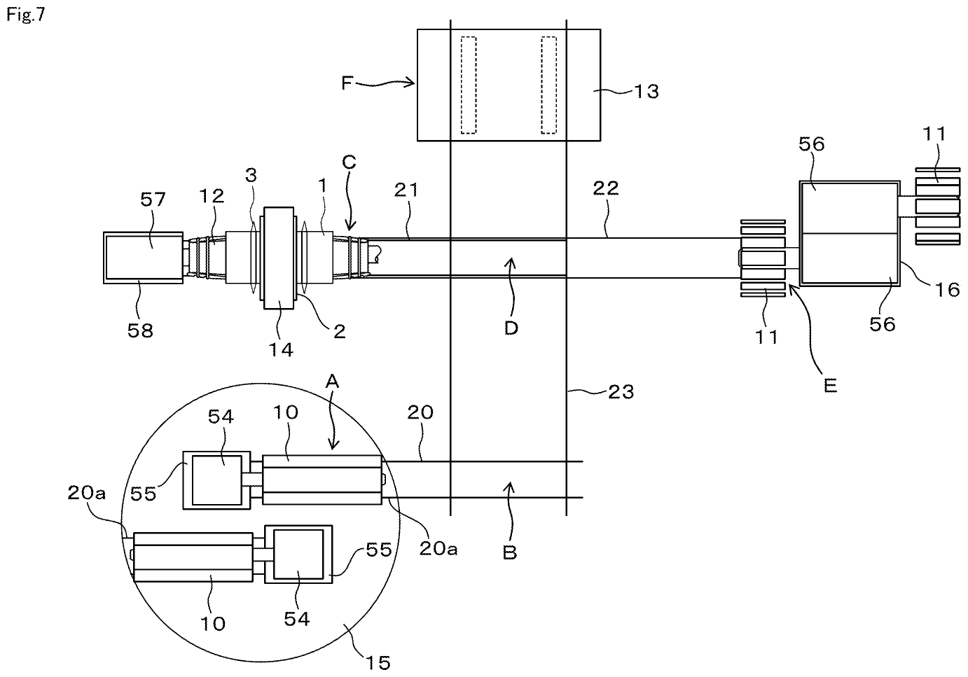

Next, as illustrated in FIG. 7, the second transfer device 14 moves to the standby position C of the shaping drum 12 while holding the belt member 2. Accordingly, the belt member 2 is disposed on the outer peripheral side of the carcass band 1 held by the shaping drum 12. Then, shaping is performed to expand the axial center portion of the carcass band 1 and the belt member 2 is attached to the outer peripheral surface of the carcass band 1. Further, the carcass band 1 is turned up at the position of the bead 3 so as to be folded back. Accordingly, the green tire is completed.

The completed green tire is inserted into a vulcanization molding mold (not illustrated) and is vulcanization molded. After vulcanization molding, a pneumatic tire is completed through necessary steps such as inspection.

### (3) Second Transfer Device and Peripheral Structure

Next, a configuration associated with the movement and the stop of the second transfer device 14 will be described.

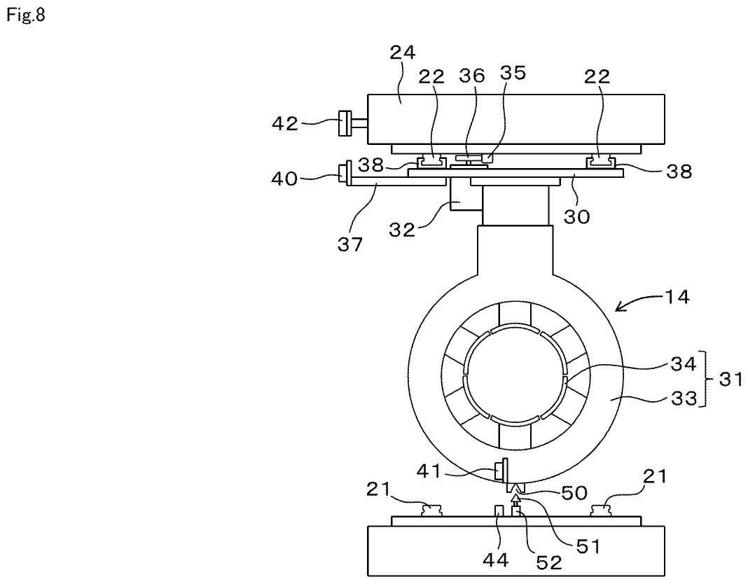

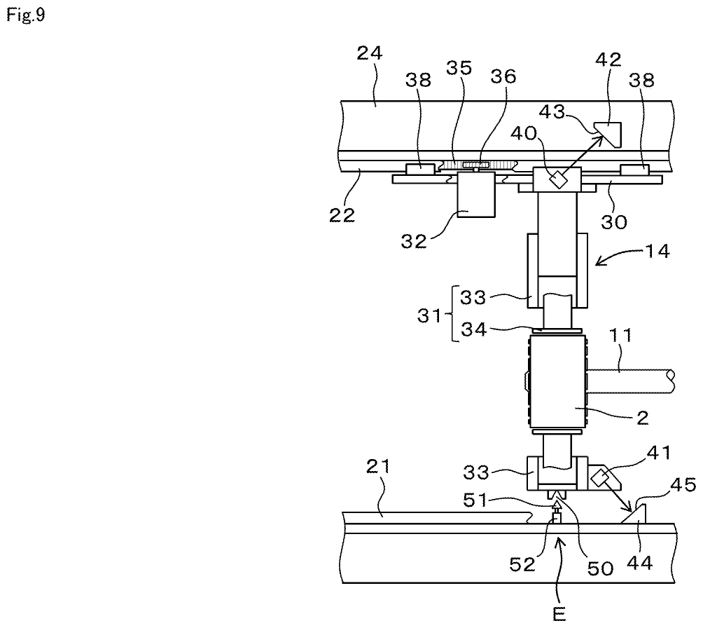

As illustrated in FIGS. 8 and 9, the second transfer device 14 is formed by fixing a holding device 31 and a servo motor 32 to a lower surface of a base plate 30.

The holding device 31 includes a frame member 33 which is circular when viewed from the axial direction and a plurality of segments 34 which are provided on the inner radial side of the frame member 33. The plurality of segments 34 are arranged in a circular shape along the inner diameter of the frame member 33. These segments 34 move forward together in a direction in which the circle contracts or move backward in a direction in which the circle expands. When these segments 34 move forward, the belt member 2 disposed inside the circle formed by the segments 34 can be held. The holding device 31 has a thin shape and, for example, the thickness of the frame member 33 (the axial length of the holding device 31) is ⅓ or less of the diameter of the frame member 33.

A plurality of slide members 38 are fixed to the upper surface of the base plate 30 in two rows as illustrated in FIG. 8. These slide members 38 respectively hold two third rails 22 above the second transfer device 14. The slide member 38 is slidable with respect to the third rail 22. With such a structure, the second transfer device 14 is slidable along two third rails 22.

Further, a rack 35 which extends in parallel to the third rail 22 is provided above the second transfer device 14. Further, a pinion 36 is provided in the output shaft of the servo motor 32 of the second transfer device 14. Then, the pinion 36 engages with the rack 35. With such a structure, when the servomotor 32 is driven, the entire second transfer device 14 moves along the third rail 22 due to the action of the pinion 36 and the rack 35. The movement and the stop of the second transfer device 14 are performed by the control of the servo motor 32.

An extension member 37 extends from the base plate 30 of the second transfer device 14 in a direction orthogonal to the axial direction of the holding device 31 in a plan view as a part of the second transfer device 14. A first laser displacement meter 40 which is a sensor is fixed to the extension destination of the extension member 37. Further, a second laser displacement meter 41 which is a sensor is fixed to the lower portion of the frame member 33 of the holding device 31. The first laser displacement meter 40 and the second laser displacement meter 41 are sensors that measure the distance to the reflector to be described later.

On the other hand, the reflector is fixed to a position facing the second transfer device 14 in a stop state at the transfer position E of the belt member 2 from the belt drum 11 to the second transfer device 14 and the transfer position C of the belt member 2 from the second transfer device 14 to the shaping drum 12 corresponding to the stop position of the second transfer device 14.

Here, the arrangement of the reflector at the transfer position E of the belt member 2 from the belt drum 11 to the second transfer device 14 will be described with reference to FIGS. 8 and 9. At the transfer position E, an upper reflector 42 is fixed to the side surface of the upper frame 24 holding the third rail 22. The upper reflector 42 is located above the third rail 22, so that the position of the upper reflector 42 is outside the movable range of the second transfer device 14. That is, the second transfer device 14 does not hit the upper reflector 42 even when the second transfer device 14 moves along the third rail 22 and passes under the upper reflector 42.

As illustrated in FIG. 9, the upper reflector 42 is provided with a reflection surface 43 which is inclined with respect to the extension direction of the third rail 22 (which is also the movement direction of the second transfer device 14). The reflection surface 43 faces downward and faces the coming direction of the second transfer device 14. Further, the reflection surface 43 faces the direction of the first laser displacement meter 40 of the second transfer device 14 when stopped at the transfer position E.

On the other hand, the first laser displacement meter 40 is fixed in a direction in which the distance to the reflection surface 43 of the upper reflector 42 is measured when the second transfer device 14 is stopped at the transfer position E. In the embodiment, the measurement direction of the first laser displacement meter 40 is perpendicular to the reflection surface 43 of the upper reflector 42.

Further, a lower reflector 44 is disposed on the floor at the transfer position E. The lower reflector 44 is disposed below the movable range of the second transfer device 14. That is, the second transfer device 14 does not hit the lower reflector 44 even when the second transfer device 14 moves along the third rail 22 and passes above the lower reflector 44.

The lower reflector 44 is provided with a reflection surface 45 which is inclined with respect to the extension direction of the third rail 22 (which is also the movement direction of the second transfer device 14). The reflection surface 45 faces upward and faces the coming direction of the second transfer device 14. Further, the reflection surface 45 faces the direction of the second laser displacement meter 41 of the second transfer device 14 when stopped at the transfer position E.

On the other hand, the second laser displacement meter 41 is fixed in a direction in which the distance to the reflection surface 45 of the lower reflector 44 is measured when the second transfer device 14 is stopped at the transfer position E. In the embodiment, the measurement direction of the second laser displacement meter 41 is perpendicular to the reflection surface 45 of the lower reflector 44.

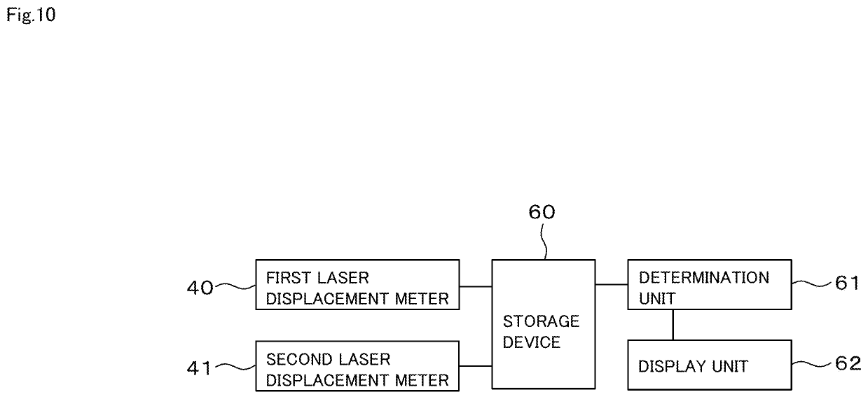

With such a configuration, when the second transfer device 14 is stopped at the transfer position E, the first laser displacement meter 40 can measure the distance to the reflection surface 43 of the upper reflector 42 and the second laser displacement meter 41 can measure the distance to the reflection surface 45 of the lower reflector 44. The first laser displacement meter 40 and the second laser displacement meter 41 are connected to a storage device 60 (see FIG. 10) and the distance measured by the first laser displacement meter 40 and the second laser displacement meter 41 is stored in the storage device 60.

Similarly, also at the transfer position C of the belt member 2 from the second transfer device 14 to the shaping drum 12, an upper reflector (not illustrated) having the same shape as that of the upper reflector 42 and a lower reflector (not illustrated) having the same shape as that of the lower reflector 44 are arranged at a position outside the movable range of the second transfer device 14.

Then, when the second transfer device 14 is stopped at the transfer position C, the first laser displacement meter 40 can measure the distance to the reflection surface of the upper reflector and the second laser displacement meter 41 can measure the distance to the reflection surface of the lower reflector. Then, the distance measured by the first laser displacement meter 40 and the second laser displacement meter 41 is stored in the storage device 60.

Further, a concave portion 50 which is a part of the positioning device is formed at the lower portion of the frame member 33 of the holding device 31, that is, a portion on the side opposite to the third rail 22 in the second transfer device 14. Further, a cotter 51 which is a part of the positioning device is provided at the stop position of the second transfer device 14, specifically, each of the transfer position E of the belt member 2 from the belt drum 11 to the second transfer device 14 and the transfer position C of the belt member 2 from the second transfer device 14 to the shaping drum 12. The cotter 51 is a wedge-shaped convex portion and is moved forward or backward by the cylinder 52.

An installation position of the cotter 51 is a position facing the concave portion 50 when the second transfer device 14 is stopped at the stop positions C and E due to the control of the servo motor 32. When the second transfer device 14 is stopped at the stop positions C and E, the cotter 51 moves toward the concave portion 50 to be fitted to the concave portion 50. Accordingly, the position of the second transfer device 14 is fixed to a position opposite to the third rail 22.

The driving of the servo motor 32 or the forward or backward movement of the cotter 51 is controlled by a control unit (not illustrated). Further, as illustrated in FIG. 10, a determination unit 61 is connected to the storage device 60 and a display unit 62 is connected to the determination unit 61. Further, a sensor such as the first laser displacement meter 40 or the second laser displacement meter 41 is connected to the storage device 60.

### (4) Movement and Stop of Second Transfer Device

The second transfer device 14 is moved along the third rail 22 as the servo motor 32 is driven and is stopped as the servo motor 32 is stopped. The stop position of the second transfer device 14 is determined by the control of the servo motor 32.

The stop of the second transfer device 14 will be described by exemplifying the stop at the transfer position E of the belt member 2 from the belt drum 11 to the second transfer device 14. First, the second transfer device 14 moving along the third rail 22 from the standby position to the belt drum 11 is stopped at the transfer position E as illustrated in FIG. 9 as the servo motor 32 is stopped.

Next, the cotter 51 moves upward to be fitted to the concave portion 50 of the frame member 33. Accordingly, the movement of the second transfer device 14 is stopped by a mechanical means such as the positioning device in addition to an electrical means such as the servo motor 32. Further, the lower portion of the second transfer device 14 is also immovably stopped by the cotter 51 in addition to the upper portion of the second transfer device 14 held by the third rail 22 to be stopped.

Next, the first laser displacement meter 40 measures the distance to the reflection surface 43 of the upper reflector 42 and transmits the measurement result to the storage device 60. Further, the second laser displacement meter 41 measures the distance to the reflection surface 45 of the lower reflector 44 and transmits the measurement result to the storage device 60.

Additionally, the first laser displacement meter 40 and the second laser displacement meter 41 may continue to measure from just before the second transfer device 14 stops. Also in that case, at least the measurement result when the cotter 51 is fitted to the concave portion 50 so that the second transfer device 14 is completely stopped is transmitted to the storage device 60.

The second transfer device 14 is repeatedly stopped at the transfer position E while producing a large number of green tires. Whenever the second transfer device 14 is stopped at the transfer position E, the measurement results of the first laser displacement meter 40 and the second laser displacement meter 41 are transmitted to the storage device 60 and the measurement results are accumulated.

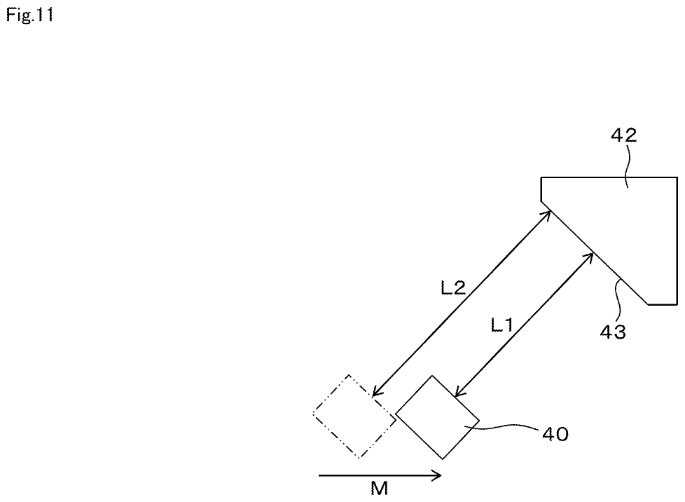

Here, when the second transfer device 14 is stopped at the regular stop position, the laser displacement meters 40 and 41 are also stopped at the regular position (a position indicated by a solid line in FIG. 11). However, when the second transfer device 14 is stopped at a position deviated from the regular stop position, the laser displacement meters 40 and 41 are also stopped at a position deviated from the regular position (for example, a position indicated by a two-dotted chain line in FIG. 11).

When the second transfer device 14 is stopped at the regular stop position and is stopped at the position deviated from the regular stop position as indicated by L1 and L2 in FIG. 11, the distance from the laser displacement meters 40 and 41 to the reflectors 42 and 44 is also changed. For that reason, when the stop position of the second transfer device 14 is deviated, the measurement results measured by the laser displacement meters 40 and 41 and acquired by the storage device 60 are also changed. Further, the arrow M in FIG. 11 indicates the movement direction of the first laser displacement meter 40.

In this way, the first laser displacement meter 40 and the upper reflector 42 form one set and constitute a position information acquiring device that acquires the information of the stop position of the second transfer device 14. Further, the second laser displacement meter 41 and the lower reflector 44 form one set and also constitute the position information acquiring device that acquires the information of the stop position of the second transfer device 14.

Further, also at the transfer position C of the belt member 2 from the second transfer device 14 to the shaping drum 12, the first laser displacement meter 40 and the second laser displacement meter 41 measure the distance to the reflection surfaces of the upper and lower reflectors after the second transfer device 14 is stopped as above and transmit the measurement results to the storage device 60. Whenever the second transfer device 14 is stopped at the transfer position C, the measurement results of the first laser displacement meter 40 and the second laser displacement meter 41 are transmitted to the storage device 60 and the measurement results are accumulated.

The determination unit 61 determines whether or not the stop position of the second transfer device 14 is deviated from the regular stop position over the allowable range or the stop position of the second transfer device 14 tends to change on the basis of the measurement result stored in the storage device 60. Then, the determination result is displayed on the display unit 62.

However, even when the determination unit 61 or the display unit 62 does not exist, a person looks at the measurement results accumulated in the storage device 60 so that the person can recognize whether or not the stop position of the second transfer device 14 is deviated from the regular position over the allowable range or the stop position of the second transfer device 14 tends to change.

### (5) Effect of Embodiment

In the embodiment, the first laser displacement meter 40 provided in the second transfer device 14 corresponding to the moving body and the upper reflector 42 provided at a position facing the second transfer device 14 in a stop state constitute one position information acquiring device. Further, the second laser displacement meter 41 provided in the second transfer device 14 and the lower reflector 44 provided at a position facing the second transfer device 14 in a stop state constitute another position information acquiring device.

The laser displacement meters 40 and 41 move in the extension direction of the third rail 22 together with the second transfer device 14 and stop at any position in the extension direction of the third rail 22. Then, the laser displacement meters 40 and 41 measure the distance to the reflection surfaces 43 and 45 of the reflectors 42 and 44.

On the other hand, in the reflectors 42 and 44, the reflection surfaces 43 and 45 are inclined with respect to the extension direction of the third rail 22. For that reason, as illustrated in FIG. 11, the distance from the laser displacement meters 40 and 41 to the reflection surfaces 43 and 45 of the reflectors 42 and 44 is changed depending on the stop positions of the laser displacement meters 40 and 41. Thus, the information of the stop position of the second transfer device 14 can be acquired on the basis of the distance to the reflection surfaces 43 and 45 of the reflectors 42 and 44 measured by the laser displacement meters 40 and 41.

Here, the tire molding apparatus may perform control such that the second transfer device 14 passes through the positions of the reflectors 42 and 44. For example, when the size of the tire to be molded is changed, the stop position of the second transfer device 14 for receiving or transferring the belt member 2 is changed and the second transfer device 14 may pass through the positions of the reflectors 42 and 44.

However, in the embodiment, since the reflectors 42 and 44 are disposed at positions other than the movable range of the second transfer device 14, the second transfer device 14 does not collide with the reflectors 42 and 44 and the position information acquiring device does not disturb the movement of the second transfer device 14 even when the second transfer device 14 passes through the positions of the reflectors 42 and 44.

In this way, according to the embodiment, it is possible to acquire the information of the stop position of the second transfer device 14 without disturbing the movement of the second transfer device 14.

Further, according to the embodiment, it is possible to acquire the information of the stop position of the second transfer device 14 without stopping the tire molding apparatus for inspection. Then, it is possible to recognize whether the stop position of the second transfer device 14 is deviated from the regular position over the allowable range or the stop position of the second transfer device 14 tends to change on the basis of the acquired information. When the stop position of the second transfer device 14 tends to change, it is possible to predict in advance that the deviation of the stop position of the second transfer device 14 will exceed the allowable range in the near future.

For that reason, the operator can perform repair or maintenance without delay so that the second transfer device 14 can be stopped at the regular position. For example, when the cotter 51 is worn or the position of the cotter 51 is deviated and the stop position of the second transfer device 14 is deviated, the operator may renew the cotter 51 or return the position of the cotter 51 on the basis of the position thereof.

By stopping the second transfer device 14 at the regular position, the transfer of the belt member 2 from the belt drum 11 to the second transfer device 14 or the transfer of the belt member 2 from the second transfer device 14 to the shaping drum 12 is always performed at the regular position in a correct posture. For that reason, the belt member 2 can be attached to a correct position of the carcass band 1 on the shaping drum 12 in a correct posture and thus the uniformity of the completed pneumatic tire can be improved.

Here, since two sensors of the first laser displacement meter 40 and the second laser displacement meter 41 are provided as the sensors for acquiring the information of the stop position of the second transfer device 14, the measurement results of two sensors do not match each other when one sensor is broken and the determination unit 61 or person can recognize that one sensor is broken. Further, one sensor can continue to acquire a correct measurement result even when the other sensor is broken.

Further, in the embodiment, a positioning device is provided by including the concave portion 50 provided in the second transfer device 14 and the cotter 51 provided at a position facing the second transfer device 14 in a stop state. For that reason, the second transfer device 14 can be mechanically stopped by using the cotter 51 in addition to the electrical stop using the servo motor 32.

Further, when the second transfer device 14 moves at a high speed and suddenly stops, the second transfer device 14 may shake even after the stop. However, in the embodiment, the cotter 51 is fitted into the concave portion 50 provided in the second transfer device 14 so that the shaking can be stopped.

Here, when the holding device 31 of the second transfer device 14 has a thin shape, a portion of the second transfer device 14 not held by the third rail 22, that is, the lower portion of the holding device 31 is particularly prone to shake. However, in the embodiment, the concave portion 50 is provided in the lower portion of the holding device 31 and the cotter 51 is fitted to the concave portion 50 so that the shaking of the lower portion of the holding device 31 can be effectively stopped.

### (6) Modified Examples

Next, modified examples will be described. Various modifications can be made to the above-described embodiment without departing from the spirit of the invention.

Hereinafter, a plurality of modified examples will be described, but the above-described embodiment may adopt any one of the plurality of modified examples to be described below or may adopt a combination of two or more of any of the modified examples to be described later. Further, the modified examples below can be modified into various forms.

### Modified Example 1

As the transfer device that moves and stops while holding the tire member, there is the first transfer device 13 in addition to the second transfer device 14 described in the above-described embodiment. The first transfer device 13 holds the carcass band 1 and moves in a direction orthogonal to the axial direction of the first transfer device 13 along the fourth rail 23.

The information of the stop position of the first transfer device 13 can be also acquired similarly to the above-described embodiment. That is, a laser displacement meter is provided in the first transfer device 13 similarly to the above-described embodiment. Further, a reflector is provided at a position facing the first transfer device 13 in a stop state at the transfer position B of the carcass band 1 from the carcass drum 10 to the first transfer device 13 or the transfer position D of the carcass band 1 from the first transfer device 13 to the shaping drum 12 corresponding to the stop position of the first transfer device 13.

Then, when the first transfer device 13 is stopped at those stop positions, the laser displacement meter measures the distance to the reflection surface of the reflector and the storage device 60 acquires the measurement result. Whenever the first transfer device 13 is stopped at those stop positions, the measurement results obtained by the laser displacement meter are acquired and accumulated in the storage device 60.

### Modified Example 2

The sensor that measures the distance to the upper reflector 42 or the lower reflector 44 is not limited to the laser displacement meter. As the sensor, a sensor that can measure the distance to the reflectors 42 and 44 by emitting a wave and reflecting it by the reflectors 42 and 44 is preferable. The waves emitted by the sensor include electromagnetic waves and sound wave, and the electromagnetic waves include light, radio waves, X-rays, and the like.

### Modified Example 3

The number of the laser displacement meters provided in the second transfer device 14 is not limited to two as in the above-described embodiment and may be one or three or more. A reflector is provided at the stop position of the second transfer device 14 as many as the laser displacement meters provided in the second transfer device 14.

### Modified Example 4

In the above-described embodiment, the measurement directions of the laser displacement meters 40 and 41 are perpendicular to the reflection surfaces 43 and 45 of the reflectors 42 and 44, but the measurement directions of the laser displacement meters 40 and 41 may face different directions.

In the above-described embodiment, the reflection surfaces 43 and 45 of the reflectors 42 and 44 are inclined with respect to the extension direction of the third rail 22 (which is also the movement direction of the second transfer device 14) so as to face the coming direction of the second transfer device 14.

In this case, the measurement directions of the laser displacement meters 40 and 41 may be directions perpendicular to the extension direction of the third rail 22. That is, the measurement direction of the first laser displacement meter 40 may face upward and the measurement direction of the second laser displacement meter 41 may face downward.

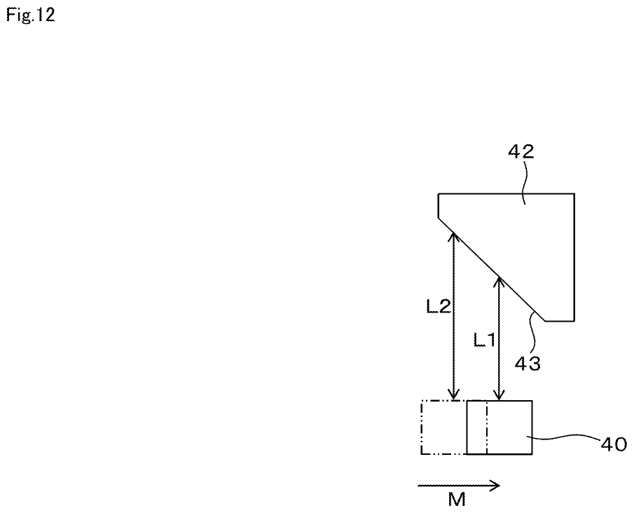

FIG. 12 illustrates a case in which the measurement direction of the first laser displacement meter 40 faces upward. Additionally, the arrow M in FIG. 12 indicates the movement direction of the second transfer device 14.

When the second transfer device 14 is stopped at the regular stop position, the first laser displacement meter 40 is also stopped at the regular position (a position indicated by a solid line in FIG. 12). However, when the second transfer device 14 is stopped at a position deviated from the regular stop position, the first laser displacement meter 40 is also stopped at a position deviated from the regular position (for example, a position indicated by a two-dotted chain line in FIG. 12). When the second transfer device 14 is stopped at the regular stop position and a position deviated from the regular stop position as indicated by L1 and L2 in FIG. 12, the distance from the first laser displacement meter 40 to the upper reflector 42 is also changed. For that reason, when the stop position of the second transfer device 14 is deviated, the measurement result measured by the first laser displacement meter 40 and acquired by the storage device 60 is also changed.

### Modified Example 5

The shape of the reflector is not limited to the shape having the reflection surfaces 43 and 45 inclined as in the above-described embodiment.

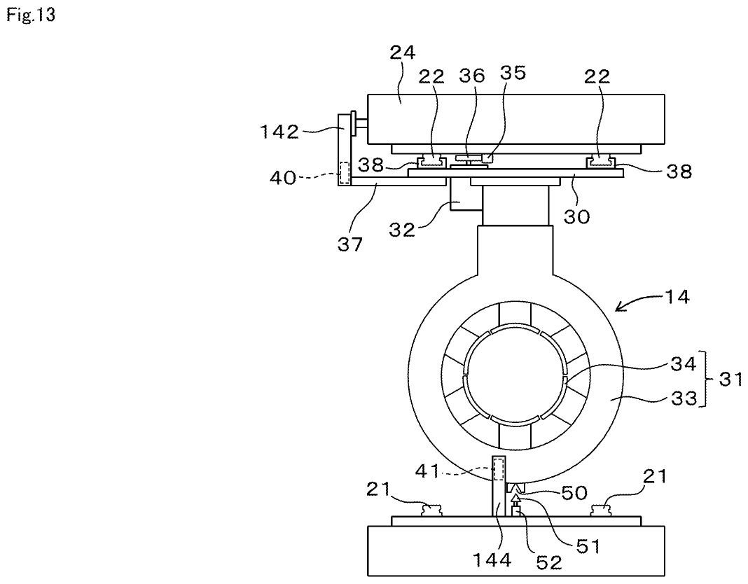

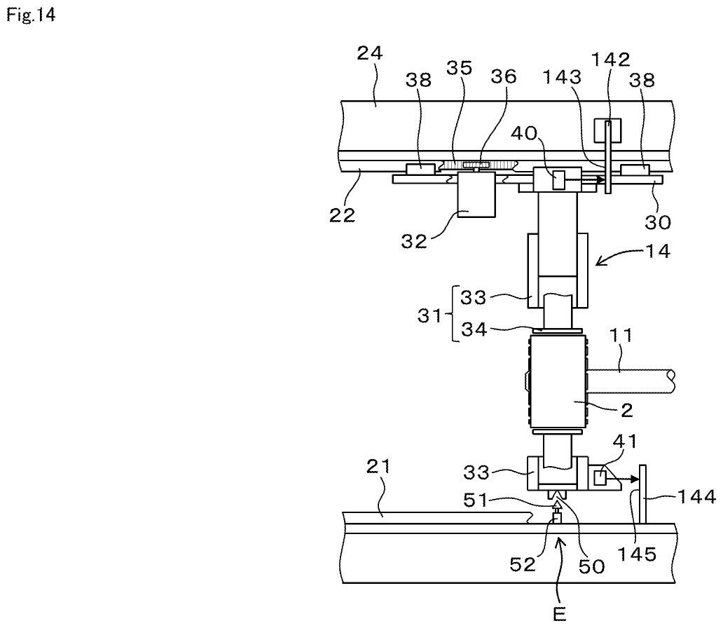

In the modified example illustrated in FIGS. 13 and 14, an upper reflector 142 is disposed on the side surface of the upper frame 24 holding the third rail 22 at the transfer position E of the belt member 2 from the belt drum 11 to the second transfer device 14. The upper reflector 142 extends to the lower side of the third rail 22. The upper reflector 142 includes a reflection surface 143 which faces the coming direction of the second transfer device 14 and is perpendicular to the extension direction of the third rail 22 (which is also the movement direction of the second transfer device 14). The reflection surface 143 faces the direction of the first laser displacement meter 40 of the second transfer device 14 when stopped at the transfer position E.

On the other hand, the first laser displacement meter 40 faces the same direction as the extension direction of the third rail 22 (which is also the movement direction of the second transfer device 14), so that the measurement direction of the first laser displacement meter 40 is perpendicular to the reflection surface 143 of the upper reflector 142.

Further, a lower reflector 144 on the floor at the transfer position E extends upward. The lower reflector 144 includes a reflection surface 145 which is perpendicular to the extension direction of the third rail 22 (which is also the movement direction of the second transfer device 14) and faces the coming direction of the second transfer device 14. The reflection surface 145 faces the direction of the second laser displacement meter 41 of the second transfer device 14 when stopped at the transfer position E.

On the other hand, the second laser displacement meter 41 faces the same direction as the extension direction of the third rail 22 (which is also the movement direction of the second transfer device 14), so that the measurement direction of the second laser displacement meter 41 is perpendicular to the reflection surface 145 of the lower reflector 144.

With such a configuration, when the second transfer device 14 is stopped at the transfer position E, the first laser displacement meter 40 can measure the distance to the reflection surface 143 of the upper reflector 142 and the second laser displacement meter 41 can measure the distance to the reflection surface 145 of the lower reflector 144.

Similarly, an upper reflector (not illustrated) having the same shape as that of the upper reflector 142 and a lower reflector (not illustrated) having the same shape as that of the lower reflector 144 are also disposed at the transfer position C of the belt member 2 from the second transfer device 14 to the shaping drum 12. Then, when the second transfer device 14 is stopped at the transfer position C, the first laser displacement meter 40 measures the distance to the reflection surface of the upper reflector and the second laser displacement meter 41 measures the distance to the reflection surface of the lower reflector.

### Modified Example 6

In the above-described embodiment, the measured distance from the laser displacement meters 40 and 41 to the reflectors 42 and 44 is acquired by the storage device 60. However, the measured distance from the laser displacement meters 40 and 41 to the reflectors 42 and 44 may be converted into the distance from a predetermined position on the third rail 22 (for example, the regular stop position of the second transfer device 14) and the converted numerical value may be acquired by the storage device 60.

### Modified Example 7

The positioning device including the concave portion 50 and the cotter 51 can be provided to stop the first transfer device 13. That is, the first transfer device 13 may be provided with the concave portion 50, the cotter 51 may be provided at a position facing the first transfer device 13 in a stop state so as to be movable forward or backward, and the cotter 51 may move forward to be fitted to the concave portion 50 when the first transfer device 13 is stopped.

### Modified Example 8

A convex portion other than the cotter 51 may be used in the positioning device.

Further, contrary to the above-described embodiment, the second transfer device 14 may be provided with a convex portion such as the cotter 51 and a concave portion may be provided at a position facing the second transfer device 14 in a stop state.

Further, at least one of the convex portion and the concave portion may be provided in the positioning device so as to be movable forward or backward.

### Modified Example 9

The layout of the tire molding apparatus is not limited to those of FIGS. 1 to 7. Here, a modified example of the layout of the tire molding apparatus will be described.

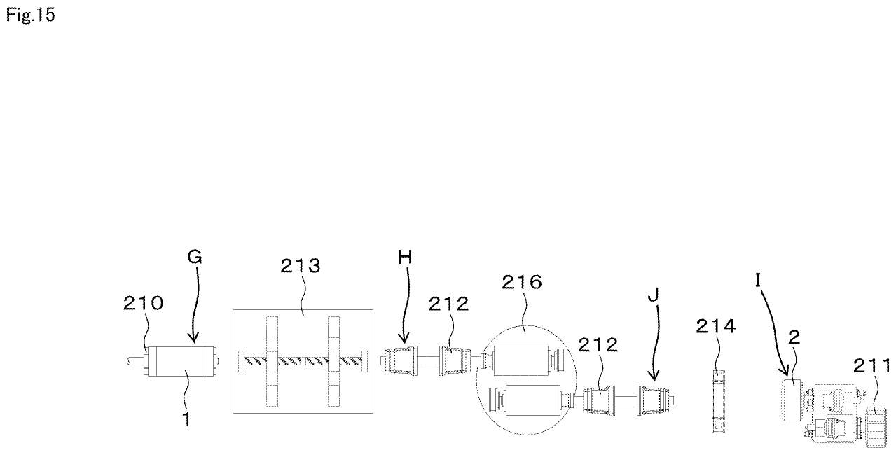

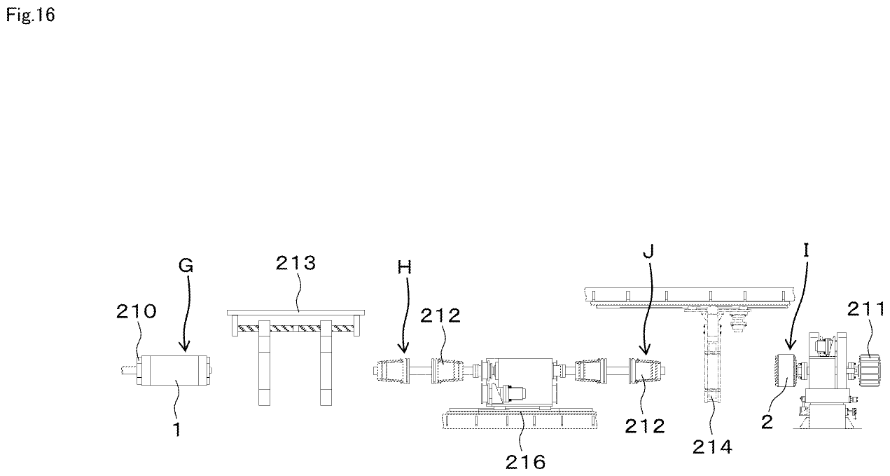

In the layout of the modified example illustrated in FIGS. 15 and 16, two shaping drums 212 are provided on one rotation table 216 in the opposite directions. Further, a carcass drum 210 is disposed on one side of the rotation table 216 and a belt drum 211 is disposed on the other side of the rotation table 216. Then, one shaping drum 212 and the carcass drum 210 are coaxially arranged and the other shaping drum 212 and the belt drum 211 are coaxially arranged.

Further, a first transfer device 213 is disposed between one shaping drum 212 and the carcass drum 210 and a second transfer device 214 is disposed between the other shaping drum 212 and the belt drum 211. The first transfer device 213 is a device that receives the carcass band 1 from the carcass drum 210 and transfers the carcass band to the shaping drum 212. Further, the second transfer device 214 is a device that receives the belt member 2 from the belt drum 211 and transfers the belt member to the shaping drum 212.

The outline of the tire molding method of the tire molding apparatus in this layout is as below.

First, the carcass band 1 is molded on the carcass drum 210 and the belt member 2 is molded on the belt drum 211. Next, the first transfer device 213 moves from the standby position to the position G of the carcass drum 210 and stops at that position. Then, the carcass band 1 is transferred from the carcass drum 210 to the first transfer device 213 at the position G.

Next, the first transfer device 213 moves to the position H of the shaping drum 212 and stops at that position. Then, the carcass band 1 is transferred from the first transfer device 213 to the shaping drum 212 at the position H. Additionally, the shaping drum 212 may move to the carcass drum 210 in the axial direction for the transfer.

Next, the rotation table 216 rotates by 180° and the shaping drum 212 receiving the carcass band 1 faces the belt drum 211.

On the other hand, the second transfer device 214 moves from the standby position to the position I of the belt drum 211 and stops at that position. Then, the belt member 2 is transferred from the belt drum 211 to the shaping drum 212 at the position I.

Next, the second transfer device 214 moves to the position J of the shaping drum 212 holding the carcass band 1 and stops at that position. Then, the belt member 2 is transferred from the second transfer device 214 to the shaping drum 212 at the position J. Accordingly, the belt member 2 is disposed on the outer peripheral side of the carcass band 1 held by the shaping drum 212. In addition, the shaping drum 212 may move to the belt drum 211 in the axial direction for the transfer.

Next, shaping is performed on the shaping drum 212 and the carcass band 1 and the belt member 2 are integrated so that a green tire is completed.

In the above-described tire molding apparatus, similarly to the above-described embodiment, a laser displacement meter is provided in at least one of the first transfer device 213 and the second transfer device 214. Further, similarly to the above-described embodiment, a reflector is provided in a part or all of the stop positions G, H, I, and J of the first transfer device 213 and the second transfer device 214. Then, when the transfer device is stopped, the laser displacement meter measures the distance to the reflector and the measurement result is acquired as the information of the stop position of the transfer device.

Further, in the tire molding apparatus, there is a case in which not only the shaping drum 212 but also the carcass drum 210 or the belt drum 211 move in the axial direction and stop at a predetermined position. In that case, the moving drum may be provided with the laser displacement meter, the reflector similar to that of the above-described embodiment may be provided at the stop position of the drum, and the laser displacement meter may measure the distance to the reflector and acquire the information of the stop position when the transfer device is stopped.

### Modified Example 10

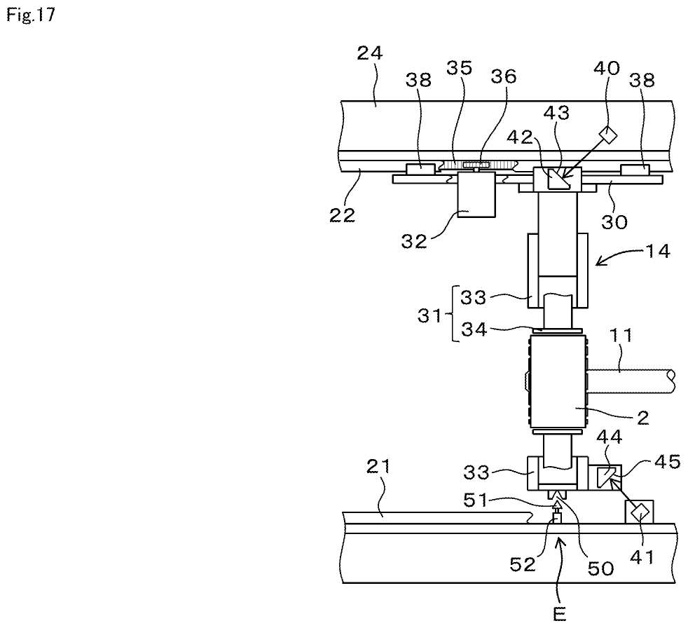

The positional relationship between the laser displacement meters 40 and 41 and the reflectors 42 and 44 may be opposite to that of the above-described embodiment. That is, as illustrated in FIG. 17, the first laser displacement meter 40 and the second laser displacement meter 41 may be provided at the positions facing the second transfer device 14 in a stop state and the upper reflector 42 and the lower reflector 44 may be provided in the second transfer device 14.

Also in this case, similar to the above-described embodiment, the first laser displacement meter 40 and the second laser displacement meter 41 are disposed at the positions outside the movable range of the second transfer device 14 and do not disturb the movement of the second transfer device 14. Further, the reflection surfaces 43 and 45 of the reflectors 42 and 44 are inclined with respect to the extension direction of the third rail 22 and the information of the stop position of the second transfer device 14 can be acquired on the basis of the distance to the reflection surfaces 43 and of the reflectors 42 and 44 measured by the laser displacement meters 40 and 41 similarly to the above-described embodiment.

### 2. Embodiment 2

In the description of Embodiment 2, basically the same components as those of Embodiment 1 are denoted by the same reference numerals as those of Embodiment 1.

### (1) Entire Configuration of Tire Molding Apparatus

The entire configuration of the tire molding apparatus of Embodiment 2 is the same as that of Embodiment 1.

### (2) Outline of Tire Molding Method

The outline of the tire molding method of Embodiment 2 is the same as that of Embodiment 1.

### (3) Configuration of Movement and Stop of Shaping Drum

The structure associated with the movement and the stop of the shaping drum 12 on the second rail 21 will be described.

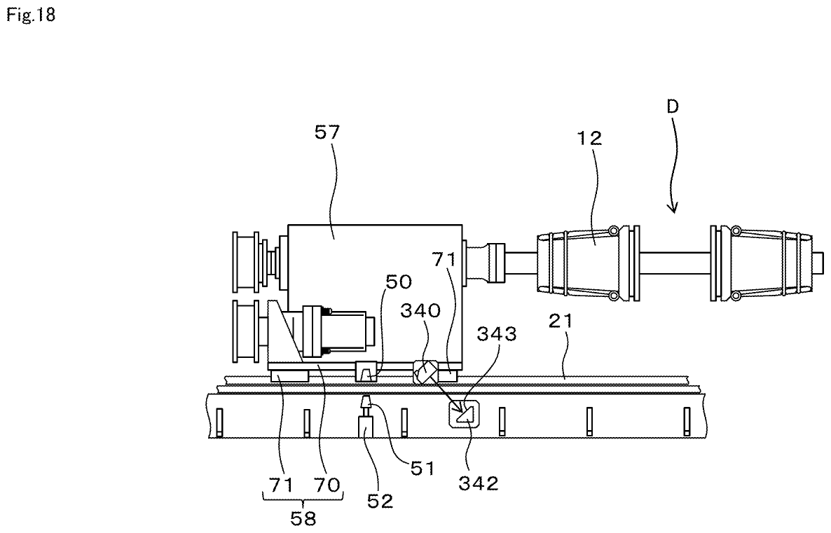

As illustrated in FIG. 18, the movement device 58 of the shaping drum 12 includes a base plate 70. The support base 57 is mounted on the upper surface of the base plate 70 and the support base 57 holds one side of the rotation shaft of the shaping drum 12.

On the other hand, a plurality of slide members 71 are provided in two rows as a part of the movement device 58 on the lower surface side of the base plate 70. These slide members 71 are mounted on two second rails 21 and are slidable with respect to two second rails 21.

Further, a servomotor (not illustrated) is provided on the base plate 70 as apart of the movement device 58. An output shaft of the servo motor extends to the lower surface side of the base plate 70 and a pinion (not illustrated) is provided at the extension destination. Further, a rack (not illustrated) which extends in parallel to the second rail 21 is provided below the movement device 58. Then, the pinion engages with the rack.

With such a structure, when the servo motor is driven, the movement device 58, the support base 57, and the shaping drum 12 move together along the second rail 21 due to the action of the pinion and the rack. The movement and the stop of the shaping drum 12 are performed by the control of the servomotor.

As illustrated in FIG. 18, one end portion of the base plate 70 is provided with a first laser displacement meter 340. The first laser displacement meter 340 is a sensor that measures the distance to the reflector to be described later. The first laser displacement meter 340 is fixed so that the measurement direction is obliquely downward.

On the other hand, a first reflector 342 is fixed to a position facing the shaping drum 12 in a stop state at the transfer position D of the carcass band 1 from the first transfer device 13 to the shaping drum 12 and the transfer position C of the belt member 2 from the second transfer device 14 to the shaping drum 12 corresponding to the stop position of the shaping drum 12.

When the transfer position D illustrated in FIG. 18 will be described as an example in detail, the first reflector 342 is disposed at a position below the second rail 21, so that the position of the first reflector 342 is outside the movable range of the shaping drum 12. That is, the shaping drum 12 or the movement device 58 does not hit the first reflector 342 even when the shaping drum 12 moves along the second rail 21 and passes above the first reflector 342.

A reflection surface 343 which faces upward and is inclined with respect to the extension direction of the second rail 21 (which is also the movement direction of the shaping drum 12) is formed in the first reflector 342. Further, the reflection surface 343 faces the direction of the first laser displacement meter 340 of the shaping drum 12 when stopped at the transfer position D.

On the other hand, the first laser displacement meter 340 is fixed in a direction in which the distance to the reflection surface 343 of the first reflector 342 is measured when the shaping drum 12 is stopped at the transfer position D. In the embodiment, the measurement direction of the first laser displacement meter 340 is perpendicular to the reflection surface 343 of the first reflector 342 as indicated by the arrow in FIG. 18.

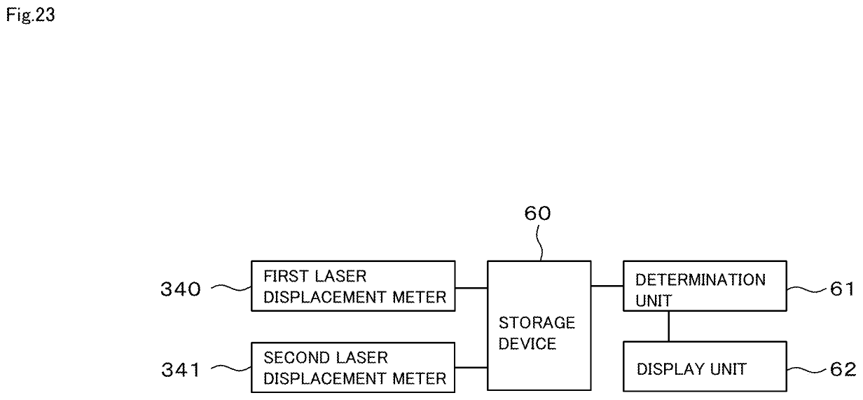

With such a configuration, when the shaping drum 12 is stopped at the transfer position D, the first laser displacement meter 340 can measure the distance to the reflection surface 343 of the first reflector 342. The first laser displacement meter 340 is connected to the storage device 60 (see FIG. 23) and the distance measured by the first laser displacement meter 340 is stored in the storage device 60.

Similarly, a reflector having the same shape as that of the first reflector 342 is disposed at a position outside the movable range of the shaping drum 12 also at the transfer position C of the belt member 2 from the second transfer device 14 to the shaping drum 12. Then, when the shaping drum 12 is stopped at the transfer position C, the first laser displacement meter 340 measures the distance to the reflection surface of the upper reflector. Then, the distance measured by the first laser displacement meter 340 is stored in the storage device 60.

Further, as illustrated in FIG. 18, a concave portion 50 which is apart of the positioning device is formed in, for example, the base plate 70 of the movement device 58 having the shaping drum 12 mounted thereon. Further, a cotter 51 which is a part of the positioning device is provided at the stop position of the shaping drum 12, specifically, each of the transfer positions C and D. The cotter 51 is a wedge-shaped convex portion and is moved forward or backward by the cylinder 52.

An installation position of the cotter 51 is a position facing the concave portion 50 when the shaping drum 12 is stopped at the stop positions C and D due to the control of the servo motor. When the shaping drum 12 is stopped at the stop positions C and D, the cotter 51 moves toward the concave portion 50 to be fitted to the concave portion 50. Accordingly, the position of the shaping drum 12 on the second rail 21 is fixed.

The driving of the servo motor or the forward or backward movement of the cotter 51 is controlled by a control unit (not illustrated). Further, as illustrated in FIG. 9, the determination unit 61 is connected to the storage device 60 and the display unit 62 is connected to the determination unit 61. Further, the first laser displacement meter 340 is connected to the storage device 60.

### (4) Movement and Stop of Shaping Drum

During the production of the green tire, the shaping drum 12 moves along the second rail 21 and is stopped at the position C and the position D. The shaping drum 12 is moved along the second rail 21 as the servo motor is driven and is stopped at the stop position on the second rail 21 as the servo motor is stopped. The stop position of the shaping drum 12 is determined by the control of the servo motor.

The stop of the shaping drum 12 will be described by exemplifying the stop at the transfer position D of the carcass band 1 from the first transfer device 13 to the shaping drum 12. First, the shaping drum 12 moving along the second rail 21 from the standby position to the transfer position D is stopped at the transfer position D as illustrated in FIG. 18.

Next, the cotter 51 moves upward to be fitted to the concave portion 50 of the movement device 58. Accordingly, the movement of the shaping drum 12 is stopped by a mechanical means such as the positioning device in addition to an electrical means such as the servo motor.

Next, the first laser displacement meter 340 measures the distance to the reflection surface 343 of the first reflector 342 and transmits the measurement result to the storage device 60. Additionally, the first laser displacement meter 340 may continue to measure from just before the shaping drum 12 stops. Also in that case, at least the measurement result when the cotter 51 is fitted to the concave portion 50 so that the shaping drum 12 is completely stopped is transmitted to the storage device 60.

When the shaping drum 12 starts to move again, the cotter 51 first comes out of the concave portion 50 and then the servo motor starts to be driven.

The shaping drum 12 is repeatedly stopped at the transfer position D while producing a large number of green tires. Whenever the shaping drum 12 is stopped at the transfer position D, the measurement result of the first laser displacement meter 340 is transmitted to the storage device 60 and the measurement result is accumulated in this way.

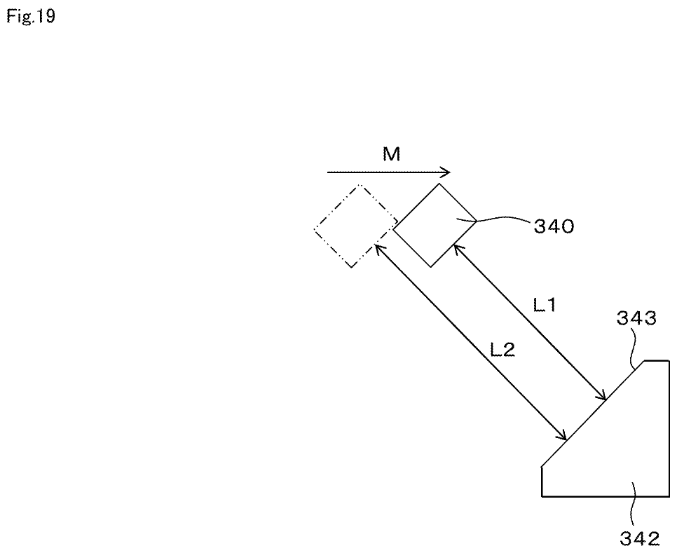

Here, when the shaping drum 12 is stopped at the regular stop position, the first laser displacement meter 340 is also stopped at the regular position (a position indicated by a solid line in FIG. 19). However, when the shaping drum 12 is stopped at a position deviated from the regular stop position, the first laser displacement meter 340 is also stopped at a position deviated from the regular position (for example, a position indicated by a two-dotted chain line in FIG. 19).

When the shaping drum 12 is stopped at the regular stop position and when the shaping drum 12 is stopped at a position deviated from the regular stop position as indicated by L1 and L2 in FIG. 19 (in FIG. 19, the arrow M indicates the movement direction of the first laser displacement meter 340), the distance from the first laser displacement meter 340 to the reflection surface 343 of the first reflector 342 is also changed. For that reason, when the stop position of the shaping drum 12 is deviated, the measurement result measured by the first laser displacement meter 340 and acquired by the storage device 60 is also changed.

Thus, it is possible to know the information of the stop position of the shaping drum 12 from the measurement result of the first laser displacement meter 340. In this way, the first laser displacement meter 340 and the first reflector 342 form one set and constitute a position information acquiring device that acquires the information of the stop position of the shaping drum 12.

Further, also at the transfer position C of the belt member 2 from the second transfer device 14 to the shaping drum 12, the first laser displacement meter 340 measures the distance to the reflection surface of the reflector after the shaping drum 12 is stopped as described above and transmits the measurement result to the storage device 60. Whenever the shaping drum 12 is stopped at the transfer position C, the measurement result of the first laser displacement meter 340 is transmitted to the storage device 60 and the measurement result is accumulated.

The determination unit 61 determines whether or not the stop position of the shaping drum 12 is deviated from the regular stop position over the allowable range or the stop position of the shaping drum 12 tends to change on the basis of the measurement result stored in the storage device 60. Then, the determination result is displayed on the display unit 62.

However, even when the determination unit 61 or the display unit 62 does not exist, a person looks at the measurement results accumulated in the storage device 60 so that the person can recognize whether or not the stop position of the shaping drum 12 is deviated from the regular position over the allowable range or the stop position of the shaping drum 12 tends to change.

### (5) Configuration for Rotation and Stop of Rotation Table

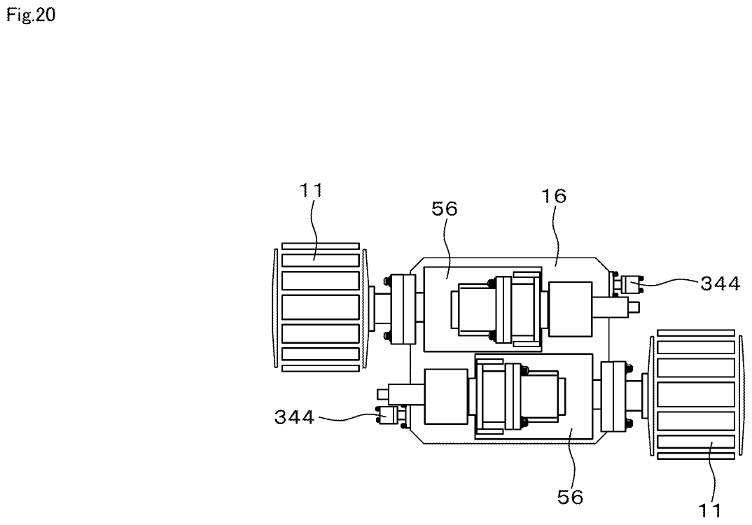

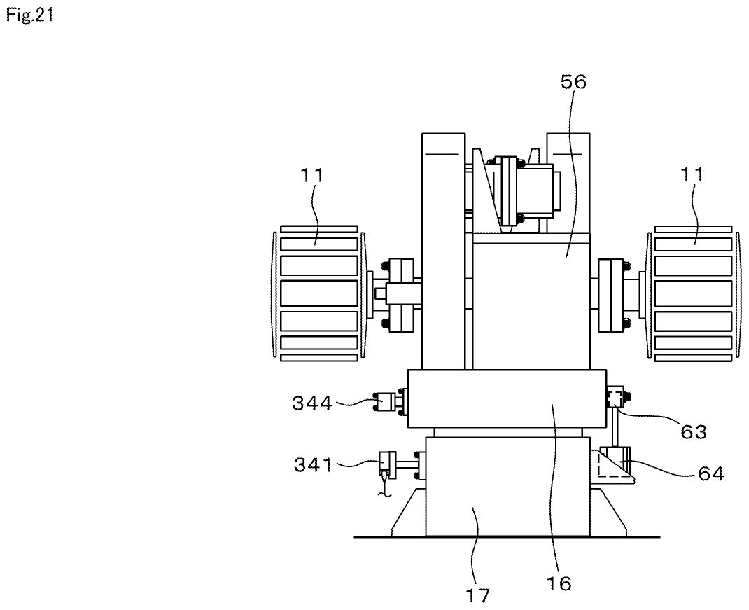

The rotation table 16 illustrated in FIGS. 20 to 22 is a rotation table that rotates by 180° within a horizontal plane in order to move the belt drum 11 between the molding position and the standby position. As illustrated in FIG. 20, two support bases 56 are mounted on the rotation table 16. Then, each of two support bases 56 holds one side of the rotation shaft of the belt drum 11. As described above, two belt drums 11 are opposite to each other. Respective portions on the rotation table 16 are disposed so as to form a rotational symmetry of 180°.

The rotation table 16 is mounted on a drive base 17. The drive base 17 has a rectangular shape in a plan view. A motor (not illustrated) is built in the drive base 17 and the motor rotates the rotation table 16. The start of the rotation of the motor is controlled by the control unit.

Further, a proximity switch (not illustrated) is provided in the vicinity of the rotation table 16. Then, when the proximity switch detects that the rotation table 16 rotates by 180°, the rotation of the motor is stopped and the rotation of the rotation table 16 is stopped.

Each of two facing side surfaces of the drive base 17 is provided with a second laser displacement meter 341. On the other hand, each second reflector 344 is provided at a position facing the second laser displacement meter 341 when the rotation table 16 is stopped in the side surface of the rotation table 16. Specifically, the side surfaces on the side of the molding position and the standby position of the belt drum 11 in the drive base 17 are respectively provided with the second laser displacement meter 341 and each side surface having the belt drum 11 in the rotation table 16 is provided with the second reflector 344.

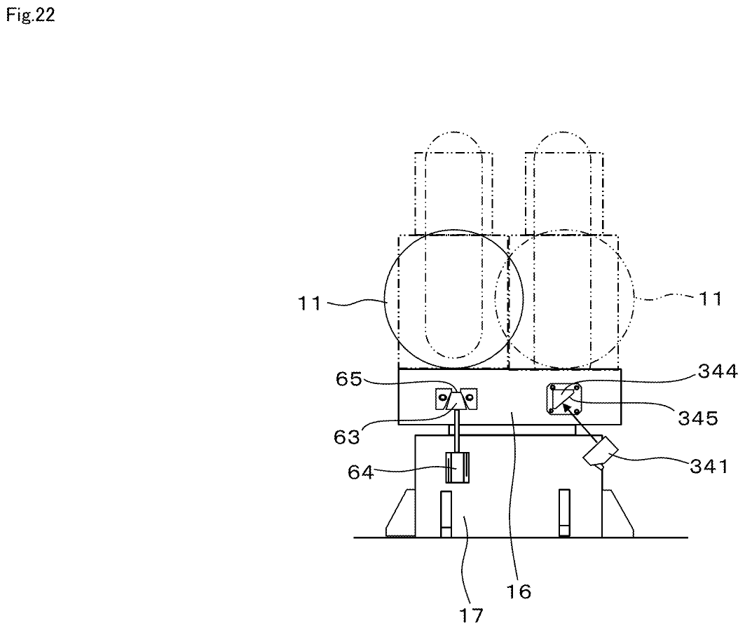

The second laser displacement meter 341 is fixed so that the measurement direction is obliquely directed upward as indicated by the arrow in FIG. 22. On the contrary, the second reflector 344 is provided with a reflection surface 345 obliquely directed downward (that is, a direction perpendicular to the reflection surface 345 is the oblique downward direction). In the embodiment, the measurement direction of the second laser displacement meter 341 is perpendicular to the reflection surface 345 of the second reflector 344.

With such a configuration, when the rotation of the rotation table 16 is stopped, the second laser displacement meter 341 faces the reflection surface 345 of the second reflector 344 and the second laser displacement meter 341 can measure the distance to the reflection surface 345. The second laser displacement meter 341 is connected to the storage device 60 (see FIG. 23) and the distance measured by the second laser displacement meter 341 is stored in the storage device 60.

A cotter 63 which is a part of the positioning device is provided in each of two facing side surfaces of the drive base 17. The cotter 63 is a wedge-shaped convex portion and is moved forward or backward by a cylinder 64. The forward or backward movement of the cotter 63 is controlled by the control unit.

On the other hand, a concave portion 65 is provided at a position facing the cotter 63 when the rotation table 16 is stopped in the side surface of the rotation table 16. Specifically, the side surfaces on the side of the molding position and the standby position of the belt drum 11 in the drive base 17 are respectively provided with the cotter 63 and each side surface having the belt drum 11 in the rotation table 16 is provided with the concave portion 65.

With such a configuration, when the rotation of the rotation table 16 is stopped, the cotter 63 moves toward the concave portion 65 to be fitted to the concave portion 65. Accordingly, the rotation table 16 is fixed so as not to be rotatable.

### (6) Rotation and Stop of Rotation Table

As described above, when the molding of the belt member 2 on the belt drum 11 at the molding position ends, the rotation table 16 rotates by 180° and stops. Accordingly, the belt drum 11 holding the belt member 2 moves to the standby position. At this time, another belt drum 11 on the rotation table 16 moves from the standby position to the molding position.

Next, the cotter 63 moves upward to be fitted to the concave portion 65 of the rotation table 16 as illustrated in FIG. 22. Accordingly, the rotation of the rotation table 16 is stopped by a mechanical means such as the positioning device in addition to an electrical means such as a motor.

Next, each of two second laser displacement meters 341 measures the distance to the reflection surface 345 of the second reflector 344 and transmits the measurement result to the storage device 60. Additionally, the second laser displacement meter 341 may continue to measure from just before the rotation of the rotation table 16 stops. Also in that case, at least the measurement result when the cotter 63 is fitted to the concave portion 65 so that the rotation table 16 is completely stopped is transmitted to the storage device 60.

When the rotation table 16 starts to rotate again, the cotter 63 first comes out of the concave portion 65 and then the motor starts to rotate so that the rotation table 16 starts to rotate.

The rotation table 16 and the belt drum 11 thereon are repeatedly rotated and stopped within the horizontal plane while producing a large number of green tires. Whenever the rotation table 16 is stopped, the measurement result of each of two second laser displacement meters 341 is transmitted to the storage device 60 and the measurement result is accumulated.

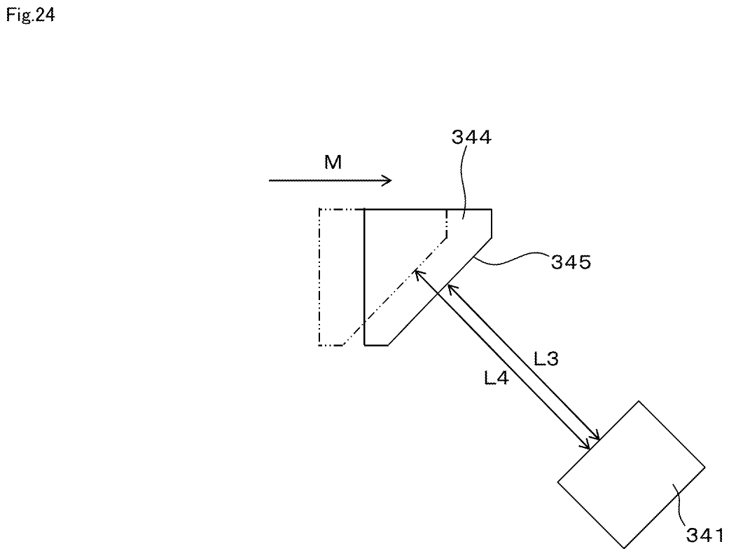

Here, when the rotation table 16 and the belt drum 11 thereon are stopped at the regular stop position, the second reflector 344 is also stopped at the regular position (a position indicated by a solid line in FIG. 24). However, when the rotation table 16 and the belt drum 11 thereon are stopped at a position deviated from the regular stop position, the second reflector 344 is also stopped at a position deviated from the regular position (for example, a position indicated by a two-dotted chain line in FIG. 24).

When the rotation table 16 and the belt drum 11 thereon are stopped at the regular stop position and when the rotation table 16 and the belt drum 11 thereon are stopped at a position deviated from the regular stop position as indicated by L3 and L4 in FIG. 24 (in FIG. 24, the arrow M indicates the movement direction of the second reflector 344), the distance from the second laser displacement meter 341 to the reflection surface 345 of the second reflector 344 is also changed. For that reason, when the stop positions of the rotation table 16 and the belt drum 11 are deviated, the measurement result measured by the second laser displacement meter 341 and acquired by the storage device 60 is also changed.

Thus, it is possible to know the information of the stop position of the rotation of the belt drum 11 within the horizontal plane from the measurement result of the second laser displacement meter 341. In this way, the second laser displacement meter 341 and the second reflector 44 form one set and constitute a position information acquiring device that acquires the information of the stop position of the belt drum 11.

The determination unit 61 determines whether or not the stop position of the belt drum 11 is deviated from the regular stop position over the allowable range or the stop position of the belt drum 11 tends to change on the basis of the measurement result stored in the storage device 60. Then, the determination result is displayed on the display unit 62.

However, even when the determination unit 61 or the display unit 62 does not exist, a person looks at the measurement results accumulated in the storage device 60 so that the person can recognize whether or not the stop position of the belt drum 11 is deviated from the regular position over the allowable range or the stop position of the belt drum 11 tends to change.

### (7) Effect of Embodiment 2

Next, an effect of the embodiment will be described. As described above, in the embodiment, the first laser displacement meter 340 is provided in the movement device 58 of the shaping drum 12 and the first reflector 342 is provided at a position facing the first laser displacement meter 340 when the movement of the shaping drum 12 is stopped. Then, the first laser displacement meter 340 measures the distance to the first reflector 342 and the measurement result is acquired as the information of the stop position of the shaping drum 12.

Further, as described above, in the embodiment, the second reflector 344 is provided in the rotation table 16 of the belt drum 11 and the second laser displacement meter 341 is provided at a position facing the second reflector 344 when the rotation of the belt drum 11 is stopped. Then, the second laser displacement meter 341 measures the distance to the second reflector 344 and the measurement result is acquired as the information of the stop position of the belt drum 11.

In this way, according to the embodiment, it is possible to acquire the information of the stop position of the shaping drum 12 or the belt drum 11 during production without stopping the entire tire molding apparatus for inspection. Then, it is possible to recognize whether the stop position of the shaping drum 12 or the belt drum 11 is deviated from the regular position over the allowable range or the stop position of the shaping drum 12 or the belt drum 11 tends to change on the basis of the acquired information. When the stop position of the shaping drum 12 or the belt drum 11 tends to change, it is possible to predict in advance that the deviation of the stop position of the shaping drum 12 or the belt drum 11 will exceed the allowable range in the near future.

For that reason, the operator can perform repair or maintenance without delay so that the shaping drum 12 or the belt drum 11 can be stopped at the regular position. For example, when the cotters 51 and 63 are worn or the positions of the cotters 51 and 63 are deviated and the stop position of the shaping drum 12 or the belt drum 11 is deviated, the operator may renew the cotters 51 and 63 or return the positions of the cotters 51 and 63 on the basis of the positions thereof.

By stopping the shaping drum 12 or the belt drum 11 at the regular position, the transfer of the carcass band 1 or the belt member 2 between the drums 11 and 12 and the transfer devices 13 and 14 is always performed at the regular position in a correct posture. For that reason, the carcass band 1 or the belt member 2 can be attached to a correct position on the shaping drum 12 in a correct posture and thus the uniformity of the completed pneumatic tire can be improved.

Further, regarding the operation of acquiring the information of the stop position of the belt drum 11, since two pairs of the second laser displacement meter 341 and the second reflector 344 are provided, the measurement results of two second laser displacement meters 341 do not match each other when one second laser displacement meter 341 is broken and the determination unit 61 or person can recognize that one second laser displacement meter 341 is broken. Further, even when one second laser displacement meter 341 is broken, the other second laser displacement meter 341 can continue to acquire a correct measurement result.

Here, since two second reflectors 344 are provided in two facing side surfaces of the rotation table 16 in a separated state, the measurement results of two second laser displacement meters 341 do not match each other even when the rotation table 16 is slightly deformed and the determination unit 61 or person can recognize the deformation of the rotation table 16.

Further, in the embodiment, the reflection surface 343 of the first reflector 342 and the reflection surface 345 of the second reflector 344 are inclined with respect to the movement direction of the shaping drum 12 or the belt drum 11. For that reason, as illustrated in FIG. 19 or 24, when the stop position of the shaping drum 12 or the belt drum 11 is different, the distance from the first laser displacement meter 340 to the reflection surface 343 of the first reflector 342 or the distance from the second laser displacement meter 341 to the reflection surface 345 of the second reflector 344 is different. For that reason, it is possible to reliably acquire the information of the stop position of the shaping drum 12 or the belt drum 11 on the basis of the measurement result of the first laser displacement meter 340 or the second laser displacement meter 341.

Further, in the embodiment, since the first reflector 342 is disposed at a position outside the movable range of the movement device 58 of the shaping drum 12, there is no concern that the movement device 58 of the shaping drum 12 collides with the first reflector 342.

Further, in the embodiment, a positioning device is provided by including the concave portion 50 provided in the movement device 58 of the shaping drum 12 and the cotter 51 provided at a position facing the concave portion 50 of the shaping drum 12 in a movement stop state. Further, a positioning device is provided by including the concave portion 65 provided in the rotation table 16 on the side of the belt drum 11 and the cotter 63 provided at a position facing the concave portion 65 of the rotation table 16 in a rotation stop state. For that reason, the movement of the shaping drum 12 and the movement of the belt drum 11 on the rotation table 16 can be mechanically stopped by using the cotters 51 and 63 in addition to the electrical stop.

### (8) Modified Examples

Next, modified examples will be described. Various modifications can be made to the above-described embodiment without departing from the spirit of the invention.

Hereinafter, a plurality of modified examples will be described, but the above-described embodiment may adopt any one of the plurality of modified examples to be described below or may adopt a combination of two or more of any of the modified examples to be described later. Further, the modified examples below can be modified into various forms.

### Modified Example 1

Regarding the position information acquiring device that acquires the information of the stop position of the shaping drum 12, the first laser displacement meter 340 may be provided at any position on the side of the shaping drum 12, that is, any portion integrated with the shaping drum 12 and moving on the second rail 21. For example, the first laser displacement meter 340 may be provided in the support base 57 that holds the shaping drum 12. Anyway, the first reflector 342 is provided at a position facing the first laser displacement meter 340 and an immovable position when the movement of the shaping drum 12 on the second rail 21 is stopped.

Further, the first reflector 342 may be provided on the side of the shaping drum 12 and the first laser displacement meter 340 may be provided at a position facing the first reflector 342 when the movement of the shaping drum 12 is stopped.

### Modified Example 2

Regarding the position information acquiring device that acquires the information of the rotational movement stop position of the belt drum 11, the second reflector 344 may be provided at any position on the side of the belt drum 11, that is, any portion rotating together with the rotation table 16. For example, the second reflector 344 may be provided in the support base 56 that holds the belt drum 11. Anyway, the second laser displacement meter 341 is provided at a position facing the reflection surface 345 of the second reflector 344 and an immovable position when the rotation of the rotation table 16 is stopped.

Further, the second laser displacement meter 341 may be provided on the side of the belt drum 11 and the second reflector 344 may be provided at a position facing the second laser displacement meter 341 when the rotation of the rotation table 16 is stopped.

### Modified Example 3

The position information acquiring device of the above-described embodiment including the laser displacement meter and the reflector can be used to acquire the information of the stop position of the carcass drum 10 on the first rail 20 and a first rail extension portion 20a. Further, the position information acquiring device of the above-described embodiment can be used to acquire the information of the rotational movement stop position of the carcass drum 10 in accordance with the rotation stop of the rotation table 15.

### Modified Example 4

The sensor that measures the distance to the first reflector 342 or the second reflector 344 is not limited to the laser displacement meter. As the sensor, a sensor that can measure the distance to the reflectors 342 and 344 by emitting a wave and reflecting it by the reflectors 342 and 344 is preferable. The waves emitted by the sensor include electromagnetic waves and sound wave, and the electromagnetic waves include light, radio waves, X-rays, and the like.

### Modified Example 5

The position information acquiring device that acquires the information of the stop position of the shaping drum 12 is not limited to one set as in the above-described embodiment and may be two sets or more.

Further, the position information acquiring device that acquires the information of the stop position of the belt drum 11 when the rotation of the rotation table 16 is stopped is not limited to two sets as in the above-described embodiment and may be one set or three sets or more.

### Modified Example 6

In the above-described embodiment, the measurement directions of the laser displacement meters 340 and 341 are perpendicular to the reflection surfaces 343 and 345 of the reflectors 342 and 344, but the measurement directions of the laser displacement meters 340 and 341 may face different directions.

In the above-described embodiment, the reflection surfaces 343 and 345 of the reflectors 342 and 344 are inclined with respect to the movement direction of the shaping drum 12 or the rotational movement direction of the rotation table 16.

In this case, the measurement directions of the laser displacement meters 340 and 341 may be direction perpendicular to the movement direction of the shaping drum 12 or the rotational movement direction of the rotation table 16. That is, the measurement direction of the first laser displacement meter 340 may face downward and the measurement direction of the second laser displacement meter 341 may face upward.

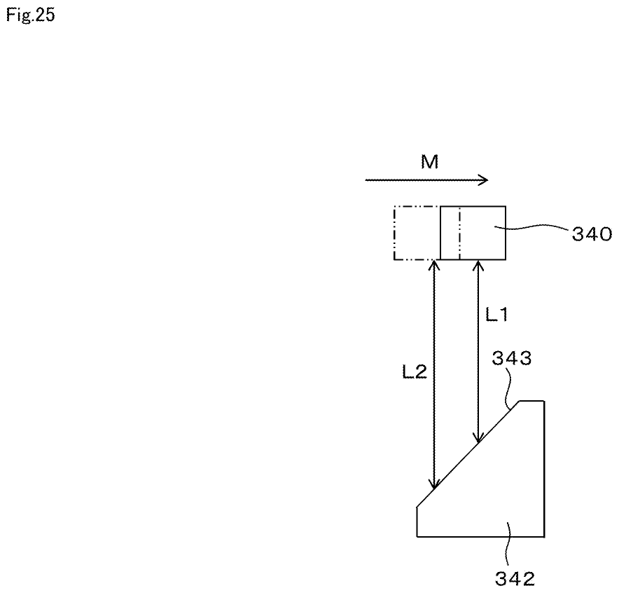

As an example, FIG. 25 illustrates a case in which the measurement direction of the first laser displacement meter 340 faces downward. Additionally, the arrow M in FIG. 25 indicates the movement direction of the second transfer device 14.

When the shaping drum 12 is stopped at the regular stop position, the first laser displacement meter 340 is also stopped at the regular position (a position indicated by a solid line in FIG. 25). However, when the shaping drum 12 is stopped at a position deviated from the regular stop position, the first laser displacement meter 340 is also stopped at a position deviated from the regular position (for example, a position indicated by a two-dotted chain line in FIG. 25). When the shaping drum 12 is stopped at the regular stop position and when the shaping drum 12 is stopped at a position deviated from the regular stop position as indicated by L1 and L2 in FIG. 25, the distance from the first laser displacement meter 340 to the reflection surface 343 of the first reflector 342 is also changed. For that reason, when the stop position of the shaping drum 12 is deviated, the measurement result measured by the first laser displacement meter 340 and acquired by the storage device 60 is also changed.

In this way, when the reflection surfaces 343 and 345 of the reflectors 342 and 344 are inclined with respect to the movement direction of the shaping drum 12 or the belt drum 11, it is possible to acquire the information of the stop position of the shaping drum 12 or the belt drum 11 if the measurement directions of the laser displacement meters 340 and 341 are directed toward the reflection surfaces 343 and 345.

### Modified Example 7

The shape of the first reflector 342 is not limited to the shape having the reflection surface 343 inclined as in the above-described embodiment.

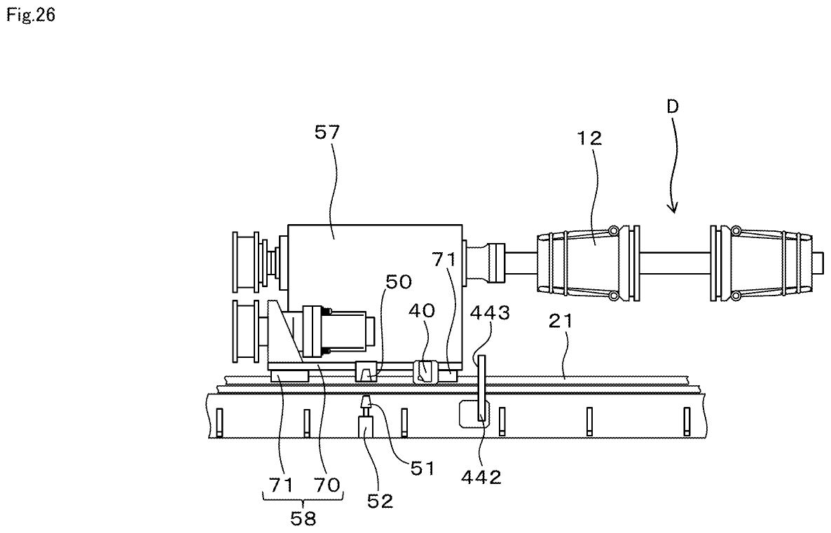

In the modified example illustrated in FIG. 26, the first reflector 442 extends to the upper side of the second rail 21. The first reflector 442 includes a reflection surface 443 which is perpendicular to the extension direction of the second rail 21 (which is also the movement direction of the shaping drum 12). The reflection surface 443 faces the direction of the first laser displacement meter 340 of the shaping drum 12 in a stop state.

On the other hand, the first laser displacement meter 340 faces the same direction as the extension direction of the second rail 21 (which is also the movement direction of the shaping drum 12), so that the measurement direction of the first laser displacement meter 340 is perpendicular to the reflection surface 443 of the first reflector 442.

With such a configuration, when the shaping drum 12 is stopped, the first laser displacement meter 340 can measure the distance to the reflection surface 443 of the first reflector 442.

### Modified Example 8

In the above-described embodiment, the measured distance from the laser displacement meters 340 and 341 to the reflectors 342 and 344 is acquired by the storage device 60. However, the measured distance from the laser displacement meters 340 and 341 to the reflectors 342 and 344 may be converted into another numerical value, for example, a coordinate on the second rail 21 or a coordinate or the like in the periphery of the rotation table 16 and the converted numerical value may be acquired by the storage device 60.

### Modified Example 9

The positional relationship between the cotters 51 and 63 and the concave portions 50 and 65 may be opposite to that of the above-described embodiment. That is, in the above-described embodiment, the concave portions 50 and 65 may be provided at the installation positions of the cotters 51 and 63 and in the above-described embodiment, the cotters 51 and 63 may be provided at the installation positions of the concave portions 50 and 65.

Further, in the positioning device, a convex portion other than the cotters 51 and 63 may be used and the convex portion may be fitted to the concave portions 50 and 65.

Further, in the positioning device, at least one of the convex portion and the concave portion may be movable forward or backward.

### Modified Example 10

The layout of the tire molding apparatus is not limited to those of FIGS. 1 to 7. Hereinafter, another layout will be described.

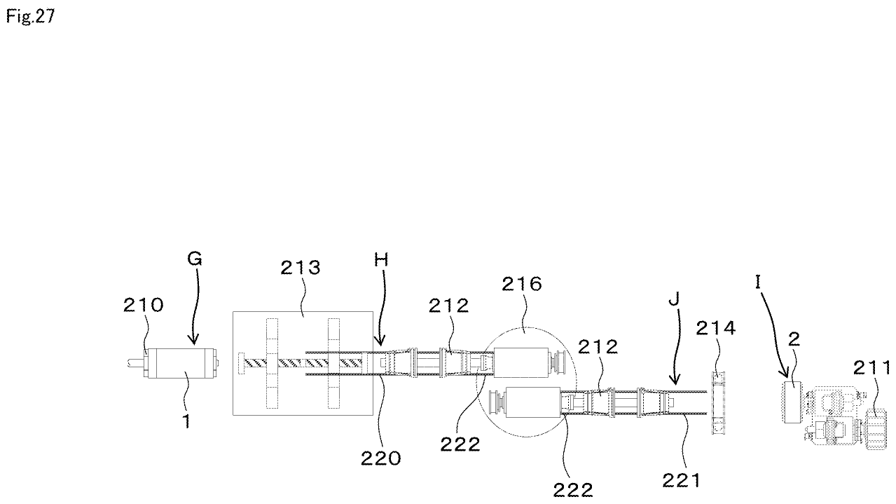

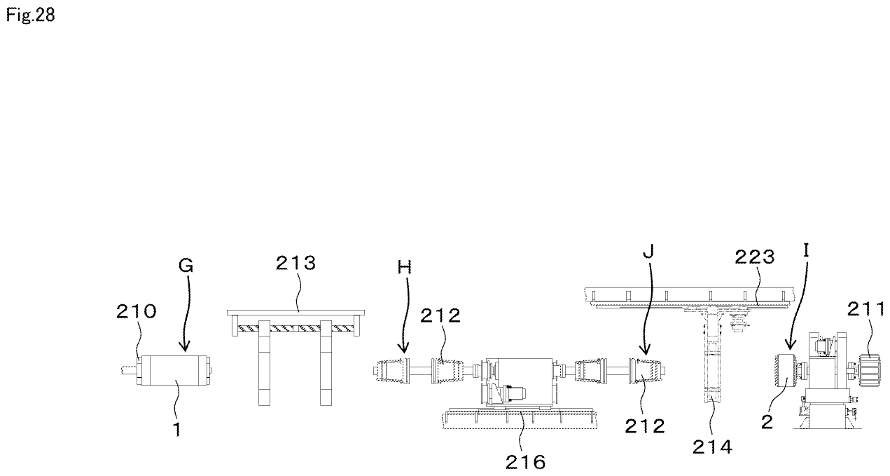

In the layout of the modified example illustrated in FIGS. 27 and 28, two shaping drums 212 are provided on one rotation table 216 in the opposite directions. Further, the carcass drum 210 is disposed on one side of the rotation table 216 and the belt drum 211 is disposed on the other side of the rotation table 216. Then, one shaping drum 212 and the carcass drum 210 are coaxially arranged and the other shaping drum 212 and the belt drum 211 are coaxially arranged.

Additionally, the belt drum 211 is mounted on the rotation table similarly to the above-described embodiment and is movable between the standby position on the side of the shaping drum 212 and the molding position on the opposite side when the rotation table rotates by 180°.

Further, the first transfer device 213 is disposed between the one shaping drum 212 and the carcass drum 210 and the second transfer device 214 is disposed between the other shaping drum 212 and the belt drum 211. The center axis of the first transfer device 213 is coaxial to the rotation shaft of the carcass drum 210. Further, the center axis of the second transfer device 214 is coaxial to the rotation shaft of the belt drum 211.

The first transfer device 213 is a device which moves along a rail (not illustrated) in the axial direction to receive the carcass band 1 from the carcass drum 210 and transfer the carcass band to the shaping drum 212. Further, the second transfer device 214 moves along the upper rail 223 in the axial direction to receive the belt member 2 from the belt drum 211 and transfer the belt member to the shaping drum 212.

Further, as illustrated in FIG. 17, a rail 220 extends from the rotation table 216 to the first transfer device 213. Similarly, a rail 221 extends from the rotation table 216 to the second transfer device 214.

Further, two table rails 222 are provided in parallel on the rotation table 216. Two table rails 222 are arranged so as to be parallel to each other and have a rotational symmetry of 180°.

When the rotation table 216 is stopped, one table rail 222 is connected to the rail 220 on the side of the first transfer device 213 to be a straight rail and the other table rail 222 is connected to the rail 221 on the side of the second transfer device 214 to be a straight rail.

For that reason, the shaping drum 212 on the side of the first transfer device 213 can move to the first transfer device 213 along the rail 220 and the shaping drum 212 on the side of the second transfer device 214 can move to the second transfer device 214 along the rail 221. Similarly to the shaping drum 12 of the above-described embodiment, the shaping drum 212 moves by the action of the rack and pinion.

The outline of the tire molding method of the tire molding apparatus in this layout is as below.

First, the carcass band 1 is molded on the carcass drum 210 and the belt member 2 is molded on the belt drum 211. Next, the first transfer device 213 moves from the standby position to the position G of the carcass drum 210 and stops at that position. Then, the carcass band 1 is transferred from the carcass drum 210 to the first transfer device 213 at the position G.

Next, the first transfer device 213 moves to the position H on the side of the shaping drum 212 and stops at that position. Further, the shaping drum 212 also moves along the rails 220 and 222 and stops at the same position H. Then, the carcass band 1 is transferred from the first transfer device 213 to the shaping drum 212 at the position H. The shaping drum 212 receiving the carcass band 1 returns to the original position on the rotation table 216.

Next, the rotation table 216 rotates by 180° and the shaping drum 212 receiving the carcass band 1 faces the belt drum 211.

Further, the second transfer device 214 moves from the standby position to the position I of the belt drum 211 and stops at that position. Then, the belt member 2 is transferred from the belt drum 211 to the second transfer device 214 at the position I.

Next, the second transfer device 214 moves to the position J on the side of the shaping drum 212 and stops at that position. Further, the shaping drum 212 holding the carcass band 1 also moves along the rails 221 and 222 and stops at the same position J. Then, the belt member 2 is transferred from the second transfer device 214 to the shaping drum 212 at the position J. Accordingly, the belt member 2 is disposed on the outer peripheral side of the carcass band 1 held by the shaping drum 212.

Next, shaping is performed on the shaping drum 212 and the carcass band 1 and the belt member 2 are integrated with each other so that a green tire is completed.

In the above-described tire molding apparatus, the shaping drum 212 moves and stops along the rails 220, 221, and 222 and rotates and stops in accordance with the rotation and the stop of the rotation table 216. Here, the position information acquiring device of the above-described embodiment can be used to acquire the information of the stop position of the shaping drum 212 on the rails 220, 221, and 222 and the information of the stop position in accordance with the stop of the rotation table 216. Further, the information of the rotational movement stop position of the belt drum 211 can be also acquired by the position information acquiring device of the above-described embodiment.

### REFERENCE SIGNS LIST

1 Carcass band
2 Belt member
3 Bead
10 Carcass drum
11 Belt drum
12 Shaping drum
13 First transfer device
14 Second transfer device
15 Rotation table
16 Rotation table
20 First rail
20a First rail extension portion
21 Second rail
22 Third rail
23 Fourth rail
24 Upper frame
31 Holding device
32 Servo motor
33 Frame member
34 Segment
35 Rack
36 Pinion
37 Extension member
38 Slide member
40 First laser displacement meter
41 Second laser displacement meter
42 Upper reflector
43 Reflection surface
44 Lower reflector
45 Reflection surface
50 Concave portion
51 Cotter
52 Cylinder
54 Support base
55 Movement device
56 Support base
57 Support base
58 Movement device
60 Storage device
61 Determination unit
62 Display unit
142 Upper reflector
143 Reflection surface
144 Lower reflector
145 Reflection surface
210 Carcass drum
211 Belt drum
212 Shaping drum
213 First transfer device
214 Second transfer device
216 Rotation table
340 First laser displacement meter
341 Second laser displacement meter
342 First reflector
343 Reflection surface
344 Second reflector
345 Reflection surface
442 First reflector
443 Reflection surface

1. A tire molding apparatus comprising:
a moving body which moves and stops along a rail; and
a position information acquiring device which acquires information of a stop position of the moving body,
wherein the position information acquiring device includes at least a reflector and a sensor as components,
wherein one component of the reflector and the sensor is provided at a position facing the moving body in a stopped state,
wherein the moving body is provided with the other component of the reflector and the sensor,
wherein the one component is disposed at a position outside a movable range of the moving body,
wherein a reflection surface of the reflector is inclined with respect to an extension direction of the rail,
wherein the sensor is a sensor that measures a distance to the reflection surface by emitting a wave and reflecting it by the reflection surface, and
wherein the information of the stop position of the moving body is acquired on the basis of the distance measured by the sensor.

2. The tire molding apparatus according to claim 1,
wherein the moving body includes a drum.

3. The tire molding apparatus according to claim 1,
wherein the moving body is a transfer device.
